(19) United States
(12) Patent Application Publication
(10) Pub. No.: US 2014/0081578 A1
(43) Pub. Date: Mar. 20, 2014

(54) Interactive Voluntary and Involuntary Caloric Intake Monitor

(71) Applicant: Robert A. Connor, Forest Lake, MN (US)

(72) Inventor: Robert A. Connor, Forest Lake, MN (US)

(21) Appl. No.: 13/616,238

(22) Filed: Sep. 14, 2012

(51) Int. Cl. G06F 19/00

(52) U.S. Cl. 702/19

(57) ABSTRACT

This invention is an interactive method and device for monitoring and measuring a person's food consumption and/or caloric intake which can function as part of an overall system for energy balance and weight management. This invention comprises collecting relatively less-intrusive data concerning a person's caloric intake, testing it for accuracy using the similarity and/or convergence of estimates, and collecting relatively more-intrusive data only if the criteria for similarity and/or convergence are not met. This invention yields a desired level of accuracy in caloric intake measurement with the least intrusion into the person's privacy and/or time. This invention provides the person with an incentive for accurate voluntary reporting of food consumption and engages them in managing their own energy balance and weight.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention relates to dieting, energy balance, and weight management.

2. Introduction and Review of the Prior Art

The United States population has some of the highest prevalence rates of obese and overweight people in the world. Further, these rates have increased dramatically during recent decades. In the late 1990's, around one in five Americans was obese. Today, that figure has increased to around one in three. It is estimated that around one in five American children is now obese. The prevalence of Americans who are generally overweight is estimated to be as high as two out of three.

This increase in the prevalence of Americans who are overweight or obese has become one of the most common causes of health problems in the United States. Potential adverse health effects from obesity include: cancer (especially endometrial, breast, prostate, and colon cancers); cardiovascular disease (including heart attack and arterial sclerosis); diabetes (type 2); digestive diseases; gallbladder disease; hypertension; kidney failure; obstructive sleep apnea; orthopedic complications; osteoarthritis; respiratory problems; stroke; metabolic syndrome (including hypertension, abnormal lipid levels, and high blood sugar); impairment of quality of life in general including stigma and discrimination; and even death. There are estimated to be over a quarter-million obesity-related deaths each year in the United States. The tangible costs to American society of obesity have been estimated at over $100 billion dollars per year. This does not include the intangible costs of human pain and suffering.

Obesity is a complex disorder with multiple interacting causal factors including genetic factors, environmental factors, and behavioral factors. A person's behavioral factors include the person's caloric intake (the types and quantities of food which the person consumes) and caloric expenditure (the calories that the person burns in regular activities and exercise). Energy balance is the net difference between caloric intake and caloric expenditure. Other factors being equal, energy balance surplus (caloric intake greater than caloric expenditure) causes weight gain and energy balance deficit (caloric intake less than caloric expenditure) causes weight loss. There are many factors that contribute to obesity. Good approaches to weight management are comprehensive in nature and engage the motivation of the person managing their own weight. Management of energy balance is a key part of an overall system for weight management. The invention that will be disclosed herein comprises a novel and useful technology that engages people in energy balance management as part of an overall system for weight management.

There are two key components to managing energy balance: (1) managing caloric intake—the types and quantities of food consumed; and (2) managing caloric expenditure—the calories burned in daily activities and exercise. Both components are essential, but there have been some large-scale studies indicating that the increase in obesity in the United States has been predominantly caused by increased food consumption. People in the U.S. are now consuming large portion sizes and too many calories. Of these calories consumed, there is too much saturated fat and not enough vitamins and minerals. Many people consistently underestimate the amount of food that they eat.

These adverse eating trends are fueling the increase in obesity despite the fact that many people are really trying to eat less, eat better, and lose weight. The American Obesity Association (AOA) estimates that around 30% of Americans are actively trying to lose weight. The average American female has tried six diets. It appears that many people want to manage their food consumption, but the vast majority of these people are unsuccessful in doing so over the long term. Long-term compliance with diets is notoriously low. With all of the exposure to food and food advertisements that tempt people in today's society, it appears that many people do not have enough willpower for long-term compliance with diet planning. The novel invention that is disclosed herein can provide these people with a new and powerful tool for monitoring their food consumption and boosting their willpower to manage their energy balance and weight over the long term.

There have been many efforts in the prior art to create technology to successfully monitor and/or control food consumption and caloric intake. Some of these approaches involve surgical procedures that reduce food consumption or limit absorption by the body of food that is consumed. Some of these approaches have been successful in reducing the calories that are ultimately absorbed by the body. However, surgical procedures tend to be invasive, expensive, have potentially-serious complications, and are not suitable for everyone who wants to lose weight. Potential adverse health effects from surgical procedures to address obesity include: blood clots, bowel or stomach obstruction, diarrhea, dumping syndrome (including bloating, cramps, and diarrhea after eating), flatulence, gallstones, hernia, hypoglycemia, infection, malnutrition (including low calcium, vitamins such as B-12, iron, protein, and thiamine), nausea, blockage of GI tract diagnostic tests, respiratory problems, stomach perforation, ulcers, and vomiting.

Due to these problems, non-surgical approaches are needed for measuring and managing food consumption and caloric intake. Accordingly, this review and the invention that will be disclosed herein are focused on non-surgical approaches to measuring food consumption and caloric intake. The vast majority of non-surgical approaches to measuring food consumption in the prior art rely on voluntary logging of food consumption and/or calories. For decades, this was done on paper. Now this can be done with the help of an application on a smart phone, electronic pad, or other mobile electronic device. However, most of these computer-assisted devices and methods still rely on voluntary actions by the person to record what they eat.

Food and calorie logging methods that depend on voluntary human action each time that a person eats anything, even a snack, can be time-consuming and cumbersome. They are notoriously associated with delays in food recording, “caloric amnesia,” errors of omission, chronic under-estimation of portion sizes, and low long-term compliance.

Recently, there have been new approaches to measuring food consumption and/or caloric intake in an automatic and involuntary manner For example, some approaches use wearable motion sensors, wearable sound sensors, or wearable cameras to monitor food consumption. However, methods of measuring a person's food consumption and/or caloric intake that are automatic and involuntary tend to be associated with high levels of intrusiveness with respect to a person's privacy. Also, methods that are entirely automatic and involuntary do not constructively engage the person in managing their own energy balance and weight. Even if accurate measurement of caloric intake can be achieved by entirely involuntary data collection methods, the lack of the person's engagement is disadvantageous because obesity is a complex condition that often involves psychological as well as physiological issues. Active engagement of the person is a desirable attribute of methods and systems of energy balance and weight management.

There remains a central problem in measuring food consumption and/or caloric intake that has not been solved by the prior art. This central problem is the tradeoff between accuracy and intrusiveness.

On the one extreme, methods that rely entirely on voluntary logging entries of food consumed (e.g. by keyboard, touch screen, voice, or camera) have a low level of intrusiveness, but also tend to be relatively inaccurate in tracking caloric intake due to low long-term compliance. With an entirely voluntary system, when a person consumes food in a rush or is in a setting in which logging food consumed would be embarrassing, the person can delay or skip the entry of food consumed. Delaying or skipping eating entries leads to low accuracy.

On the other extreme, methods with high-level automatic, involuntary monitoring of activities (such as a wearable camera that continually records video images) can be very accurate in tracking caloric intake, but can also be relatively intrusive with respect to the person's privacy. Entirely automatic and involuntary methods also tend to lack active engagement of the person. Personal engagement is useful for addressing obesity in a holistic manner.

In between these two extremes are systems with low-level automatic, involuntary monitoring of activities (such as a wearable motion sensor) that can be somewhat accurate in tracking caloric intake and relatively nonintrusive.

There have been efforts to resolve this central tradeoff between accuracy and intrusiveness in the prior art. With respect to voluntary data collection methods, some people have sought to increase the accuracy of voluntary systems by adding “reminder” mechanisms such as phone calls, text messages, and periodic inquiries. However, people who ignore making entries in a food consumption log are also free to ignore reminders.

Rather than improving compliance and accuracy, such methods may reduce compliance and accuracy because they become a nuisance.

With respect to involuntary data collection methods, some people have sought to decrease the intrusiveness of involuntary systems by adding automatic screening mechanisms that automatically recognize and screen out privacy-compromising images or sounds. However, some people might not find comfort in these automatic screening mechanisms. In some respects, they may be compared to the full-body clothing-penetrating scanners that are now found in airports. Although there are supposed to be strict safeguards on who sees these full-body scans and what happens to these images, errors are possible once these images are created. Many people question whether the level of intrusiveness on privacy caused by these full-body scanners is really warranted in all cases. Perhaps less-intrusive screening mechanisms might be acceptable for general use and full-body scanning might only be warranted when indicated by the results of the less-intrusive methods.

People have also combined food consumption information collected by involuntary and voluntary means in an effort to find the optimal combination that achieves satisfactory accuracy with relatively low intrusiveness. For example, they have designed systems in which involuntary detection of a probable eating event triggers a prompt asking the person to enter voluntary information concerning the eating event. They have also designed systems that integrate involuntary and voluntary data into a single estimation model to predict caloric intake more accurately than either involuntary or involuntary data alone. However, suppose that a person would be 100% compliant with voluntary entry of food consumption that would be sufficient by itself to accurately measure caloric intake. Why should such a person be subjected to redundant and unnecessary intrusive involuntary data collection?

FIGS. 1 through 4 show some of the most common methods for measuring food consumption and/or caloric intake in the prior art. These figures representing common methods in the prior art are provided in order to highlight the differences between the prior art approaches in FIGS. 1 through 4 and the embodiments of this present invention that will be shown in later figures.

FIG. 1 shows a basic method of measuring food consumption and/or caloric intake based on voluntary data only. Voluntary data about food consumption is data that is collected by voluntary action performed by a person in association with an eating event other than the actual action of eating. The method in FIG. 1 has two steps: (101) receiving voluntary data about food consumption from voluntary action performed by the person; and (102) estimating caloric intake based on this voluntary data only. Examples of voluntary action can include writing, typing, touching a screen, speech, and taking pictures.

FIG. 2 shows a basic method of measuring food consumption and/or caloric intake based on involuntary data only. Involuntary data about food consumption is data that is collected automatically, such as by a sensor worn on the person, without requiring any voluntary action by the person in association with an eating event other than the actual action of eating. The method in FIG. 2 has two steps: (201) receiving involuntary data about food consumption from one or more sensors worn in or on the person; and (202) estimating caloric intake based on this involuntary data only. Examples of involuntary data can include data that is automatically collected from wearable motion sensors, wearable sound sensors, and wearable cameras.

FIG. 3 shows a method of measuring food consumption and/or caloric intake based on a combination of involuntary data and voluntary data that are independently collected. The method in FIG. 3 has three steps: (201) receiving involuntary data about food consumption from one or more sensors worn in or on the person; (101) receiving voluntary data about food consumption from voluntary action performed by the person; and (301) estimating caloric intake based on this involuntary data and/or voluntary data. The method shown in FIG. 4 is like that in FIG. 3 except that involuntary data about food consumption prompts the person to enter voluntary data about food consumption. As an example of the latter, a wearable motion sensor or sound sensor may detect probable food consumption and prompt the person to enter specifics concerning the types and quantities of food consumed.

However, none of these methods successfully solve the tradeoff between accuracy and intrusiveness in collecting data about food consumption and caloric intake. The optimal combination of involuntary vs. voluntary data, or the optimal combination of different levels of involuntary data, depends on their relative accuracy. This differs between people and can also vary over time for a given person. If a person is very compliant in their use of an entirely voluntary food consumption log, then accuracy can be achieved without any need for involuntary information. However, if a person has poor compliance in their voluntary entry of food consumption, then involuntary collection of information is required to achieve satisfactory accuracy. The optimal blend of voluntary vs. involuntary data collection, or different levels of involuntary data collection, depends on the relative accuracy and privacy offered by each type of data collection. This differs between people and can vary over time. The methods shown in prior art FIGS. 1 through 4 do not solve this problem.

The desired solution to this tradeoff between accuracy and intrusiveness in collecting food consumption data, not found in the prior art, would incorporate explicit mechanisms for empirically verifying the accuracy of food consumption data from different data sources and adjust the mix of data from these sources accordingly. The desired solution could start with less-intrusive data collection means and only escalate to more-intrusive data collection means if the results of less intrusive data collection are empirically demonstrated to be inaccurate. A desired solution could also engage the person in management of their own energy balance and weight. We will discuss the desired solution in depth in subsequent sections of this disclosure when we disclosure the present invention. We only mention the desired solution here to highlight the need that remains unaddressed by the prior art.

The following are relevant examples of innovative prior art, some of which seek to address the central problem of accuracy vs. intrusiveness in measuring food consumption and caloric intake. Some of these examples combine involuntary and voluntary data concerning food consumption in creative ways. Some of them have adaptive mechanisms that enable a system to estimate the caloric value of skipped meals based on a person's eating habits. However, none of them achieve the optimal solution to the tradeoff between accuracy and intrusiveness.

Brown (U.S. Patent Application 20080262557, “Obesity Management System”) appears to disclose a system and method for obesity management that includes an interactive user interface and remote monitoring capability. This system can be embodied in an implant that automatically collects periodic measurements of parameters affecting a person's obesity. User interactive sessions for calibration ensure more accurate feedback.

Cox (U.S. Patent Application 20030076983, “Personal Food Analyzer”) appears to disclose a system that takes two separate pictures of food, automatically identifies the food, and then estimates the caloric intake associated with the food. If the automated system makes a mistake in food identification, then the person can correct this mistake manually.

Fernstrom et al. (U.S. Patent Application 20090012433, “Method, Apparatus and System for Food Intake and Physical Activity Assessment”) appear to disclose a device worn on a person that continuously collects video data, including video images of eating events and other physical activities. The device can also collect sound data. The device can be worn like a necklace around a person's neck. Collected data is analyzed, in a largely-automated manner, to identify food consumed and other physical activities. For privacy reasons, the system includes automatic mechanisms to identify images of people and to screen out such images from the images retained in memory.

Hoover et al. (U.S Patent Application 20100194573, “Weight Control Device”) appear to disclose a device worn on a person that uses a motion sensor to estimate the number and timing of bites of food consumed by the person. In an example, the device can be worn on the person's wrist or hand. Long term data analysis can be used to verify the accuracy of bite estimation.

Karnieli (U.S. Patent Application 20020022774 and U.S. Pat. No. 6,508,762, “Method for Monitoring Food Intake”) appears to disclose a system including a camera worn on a person that takes pictures of food placed in front of the person, identifies the food, and then provides feedback concerning whether it is acceptable for the person to eat the food or not. If the system makes a mistake in food identification, then the person can correct this mistake manually.

Mault et al. (U.S. Patent Applications 20010049470, “Diet and Activity Monitoring Device” and 20030065257, “Diet and Activity Monitoring Device,” and U.S. Pat. No. 6,513,532, “Diet and Activity-Monitoring Device”) appear to disclose a body activity monitor worn by a person, with one or more sensors, that can automatically create an “activity flag” each time that a person eats. These sensors may include a motion sensor, imaging sensor, or GPS sensor. The “activity flag” can include motion, image, sound, and/or location data. The system can prompt the person for more information based on activity flags. In various examples, identification of food consumed can be done voluntarily by the person wearing the monitor as prompted by the “activity flags”, can be done by a person in a remote location using data transfer, or can be done automatically by the system.

Pacione et al. (U.S. Patent Application 20050113650, “System for Monitoring and Managing Body Weight and Other Physiological Conditions Including Iterative and Personalized Planning, Intervention and Reporting Capability”) appear to disclose a device that combines information from a physiological sensor and voluntary information from a person to estimate caloric intake. The system uses adaptive and inferential methods to simplify food entry. If the person cannot remember what they ate for a particular meal, then the system can insert an estimated number of calories based on the person's historical eating habits.

Shalon et al. (U.S. Patent Applications 20060064037, “Systems and Methods for Monitoring and Modifying Behavior,” 20110125063, “Systems and Methods for Monitoring and Modifying Behavior,” 20110276312, “Device for Monitoring and Modifying Eating Behavior,” and U.S. Pat. No. 7,914,468, “Systems and Methods for Monitoring and Modifying Behavior”) appear to disclose a wearable device with sound sensors to detect non-verbal acoustic energy or a jaw motion sensor. The device can detect chewing and create a log of food consumed. In an example, the system can detect an eating event automatically and prompt the user to enter what they ate via a menu-driven interface or a voice-activated interface. Alternatively, the system may automatically identify the type of food consumed using a chemical sensor. The person can also manually enter an eating event. The system can adapt to the person's eating habits and can be calibrated using body mass detection means. If the person does not enter information for a meal, then the system can insert an estimated number of calories based on the person's historical eating habits.

Srivathsa et al. (U.S. Patent Application 20070106129, “Dietary Monitoring System for Comprehensive Patient Management”) appear to disclose a device with at least one physiological sensor that can monitor food consumption without manual input or even with incorrect manual input. Sensors can be selected from the group consisting of: a sodium sensor, a weight measuring sensor, a blood pressure sensor, a heart rate sensor, an INR/Coumadin sensor, a glucose sensor, a respiration sensor, an insulin sensor, a temperature sensor, and a hydration sensor. Deviation of collected data from an expected dietary model can result in reports or alarms.

Stivoric et al. (U.S. Patent Applications 20040152957, “Apparatus for Detecting, Receiving, Deriving and Displaying Human Physiological And Contextual Information” and 20080275309, “Input Output Device for Use with Body Monitor,” and U.S. Pat. No. 7,285,090, “Apparatus for Detecting, Receiving, Deriving and Displaying Human Physiological and Contextual Information” and U.S. Pat. No. 7,959,567, “Device to Enable Quick Entry of Caloric Content”) appear to disclose a device that is worn on a person to track caloric intake and expenditure. The device analyzes discrepancies between predicted weight and actual weight to estimate caloric amounts. When automatic interpretation of data is uncertain, the device prompts the person with questions. Stivoric et al. (U.S. Pat. No. 7,020,508, “Apparatus for Detecting Human Physiological and Contextual Information”) appears to disclose a device with physiological sensors which determine whether a person has complied with a predetermined routine.

Teller et al. (U.S Patent Applications 20040133081, 20080167536, 20080167537, 20080167538, 20080171920, 20080171921, and 20080171922, “Method and Apparatus for Auto Journaling of Body States and Providing Derived Physiological States Utilizing Physiological and/or Contextual Parameter” and U.S. Pat. No. 8,157,731, “Method and Apparatus for Auto Journaling of Continuous or Discrete Body States Utilizing Physiological and/or Contextual Parameters”) appear to disclose a calorie tracking system with one or more sensors that can fill in gaps for missing meals based on historical eating patterns. The device analyzes discrepancies between predicted weight and actual weight to estimate caloric amounts. When the device is uncertain how to interpret data, it prompts the person with questions.

These examples of prior art represent advances in the field of measurement of food consumption and caloric intake, which is a key part of energy balance and weight management. However, there remains a need for a method and device to automatically adjust the tradeoff between accuracy and intrusiveness based on empirical verification of food consumption accuracy over time. In the next section, we will discuss how the present invention meets this need.

### SUMMARY OF THIS INVENTION

The invention disclosed herein provides an optimal and adaptive solution to the tradeoff between accuracy and intrusiveness when measuring a person's food consumption and/or caloric intake. This solution has not been provided by the prior art. This invention automatically adjusts the tradeoff between accuracy and intrusiveness based on empirical verification of the accuracy of estimates of food consumption and/or caloric intake. This invention also advantageously engages the person in managing their own energy balance and weight. It gives the person incentives for accurate voluntary reporting of food consumption and/or caloric intake. This invention can function as part of an overall system for energy balance and weight management. This invention can be embodied in a method or a device.

This invention can be embodied in an iterative method to measure a person's food consumption and/or caloric intake wherein two estimates of caloric intake from different data sources are compared. One estimate is based on involuntary data concerning food consumption that is collected from relatively non-intrusive sensors and one estimate is based on voluntary data concerning food consumption that comes from action by the person in association with an eating event other than the actual action of eating. Additional data from relatively more-intrusive sensors is only collected if the initial estimates of food consumption and/or caloric intake do not meet criteria for similarity and/or convergence.

This invention can also be embodied in an iterative method to measure a person's food consumption and/or caloric intake wherein the predicted weight gain or loss for the person is compared to the actual weight gain or loss for the person. If predicted vs. actual weight gain or loss do not meet criteria for similarity and/or convergence, then additional information concerning food consumption is collected from relatively more-intrusive sensors.

This invention can be embodied in a wearable device with multiple sensors to measure food consumption and/or caloric intake. For example, this invention can be embodied in a device for measuring a person's caloric intake comprising: (a) a first sensor and/or user interface that collects a first set of data concerning what the person eats; (b) a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and (c) a second sensor and/or user interface that collects a second set of data concerning what the person eats if the criteria for similarity and/or convergence of predicted and actual weight change are not met.

In these method and device embodiments, this invention automatically and iteratively adjusts the tradeoff between accuracy and intrusiveness based on empirical verification of caloric intake measurement accuracy over time. In this manner, this invention can achieve a desired level of accuracy in measurement of food consumption and/or caloric intake, while minimizing intrusiveness. In the process, this invention can advantageously engage the person in accurate measurement of their caloric intake by rewarding accurate voluntary reporting of caloric intake with lower levels of intrusiveness.

This invention can provide a higher level of accuracy in the measurement of food consumption and/or caloric intake than that provided by entirely-voluntary methods of caloric intake measurement in the prior art. This invention can also provide a lower level of intrusiveness (and greater engagement of the person) than that of entirely-involuntary methods of caloric intake measurement in the prior art. This invention also has advantages over methods in the prior art that combine voluntary and involuntary data collection because this invention automatically and iteratively adjusts the mix and levels of data collection based on empirical evidence in order to achieve the desired level of measurement accuracy with minimal intrusiveness. This invention also engages the person in management of their own energy balance and weight by providing incentives for the person to accurately report voluntary data concerning food consumption.

### INTRODUCTION TO THE FIGURES

Figures showing embodiments of this invention begin with FIG. 5. FIGS. 5 through 31 show examples of how this invention may be embodied in a method or a device, but they do not limit the full generalizability of the claims.

FIG. 5 shows an iterative method to measure caloric intake wherein two caloric intake estimates based on involuntary and voluntary data, respectively, are compared and additional voluntary data is only collected if these estimates do not meet criteria for similarity and/or convergence.

FIG. 6 is like FIG. 5, except that additional involuntary data is also collected if estimates do not meet criteria for similarity and/or convergence.

FIG. 7 shows a method for measuring caloric intake in which data collection can escalate from a first, less-intrusive level to a second, more-intrusive level, but only if needed because caloric intake estimates from the first level do not meet criteria for similarity and/or convergence.

FIG. 8 is like FIG. 7, except that first and second level involuntary data sensors are specified as motion and imaging sensors, respectively.

FIG. 9 is like FIG. 7, except that first and second level involuntary data sensors are specified as sound and imaging sensors, respectively.

FIG. 10 shows a method for measuring caloric intake in which data collection can escalate from a first level, to a second level, to a third level, but only if needed because estimates of caloric intake from a given level do not meet criteria for similarity and/or convergence.

FIG. 11 shows a method for measuring caloric intake in which operation of an imaging sensor escalates from motion-triggered operation to continuous operation, but only if estimates of caloric intake involving motion-triggered operation do not meet criteria for similarity and/or convergence.

FIG. 12 is like FIG. 11, except that the first-level operation of the imaging sensor is sound-triggered operation.

FIG. 13 shows a method for measuring caloric intake wherein the estimation process is refined if predicted vs. actual weight gain or loss do not meet criteria for similarity and/or convergence.

FIG. 14 shows a method for measuring caloric intake wherein additional data concerning food consumption is collected if predicted vs. actual weight gain or loss do not meet criteria for similarity and/or convergence.

FIG. 15 is like FIG. 14, except that additional data concerning caloric expenditure is also collected if predicted vs. actual weight gain or loss do not meet criteria for similarity and/or convergence.

FIG. 16 shows a method for measuring caloric intake in which data collection can escalate from a first, less-intrusive level to a second, more-intrusive level, but only if needed because predicted vs. actual weight gain or loss do not meet criteria for similarity and/or convergence in the first level.

FIG. 17 is like FIG. 16, except that first and second level involuntary data sensors are specified as motion and imaging sensors, respectively.

FIG. 18 is like FIG. 16, except that first and second level involuntary data sensors are specified as sound and imaging sensors, respectively.

FIG. 19 shows a method for measuring caloric intake in which operation of an imaging sensor can escalate from motion-triggered operation to continuous operation, but only if needed because predicted vs. actual weight gain or loss do not meet criteria for similarity and/or convergence.

FIG. 20 is like FIG. 19, except that the first-level operation of the imaging sensor is sound-triggered operation.

FIGS. 21 through 27 show a device to measure caloric intake that is worn on a person's wrist, wherein this device includes a motion sensor, a microphone and speaker unit, a video camera, and a data processing and transmission unit.

FIG. 22 shows this device as a person tilts a glass up to their mouth.

FIG. 23 shows this device asking the person what they are eating.

FIG. 24 shows this device receiving a response from the person concerning what they are eating.

FIG. 25 shows this device receiving information about a person's weight from a scale.

FIGS. 26 and 27 show this device taking pictures of what a person is consuming if needed because predicted vs. actual weight gain or loss do not meet criteria for similarity and/or convergence.

FIGS. 28 through 31 show a device to measure caloric intake that is worn on a person's neck, wherein this device includes a microphone and speaker unit, a video camera, and a data processing and transmission unit.

FIG. 28 shows this device detecting biting, chewing, or swallowing sounds as a person eats.

FIG. 29 shows this device receiving information from the person concerning what they are eating.

FIG. 30 shows this device receiving information about a person's weight from a scale.

FIG. 31 shows this device taking pictures of what a person is consuming if needed because predicted vs. actual weight gain or loss do not meet criteria for similarity and/or convergence.

### DETAILED DESCRIPTION OF THE FIGURES

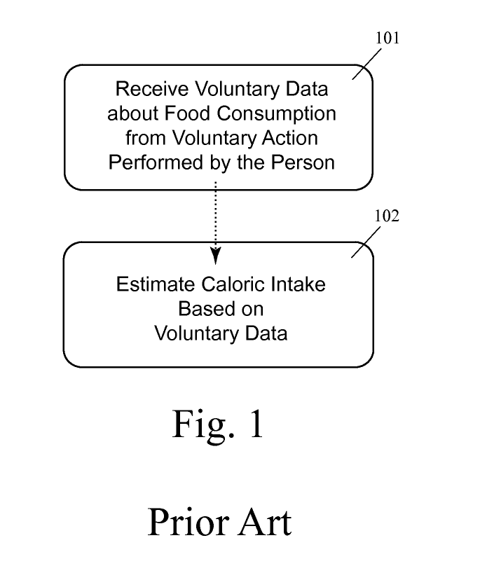

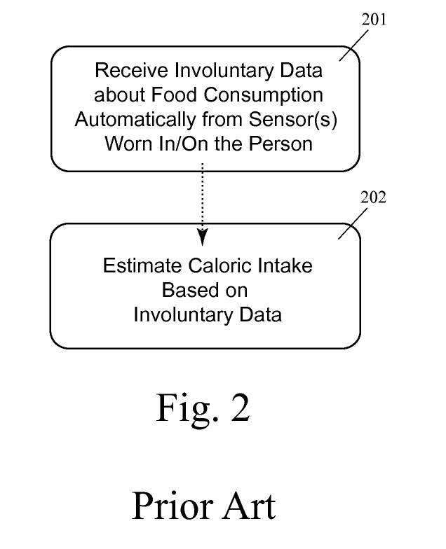

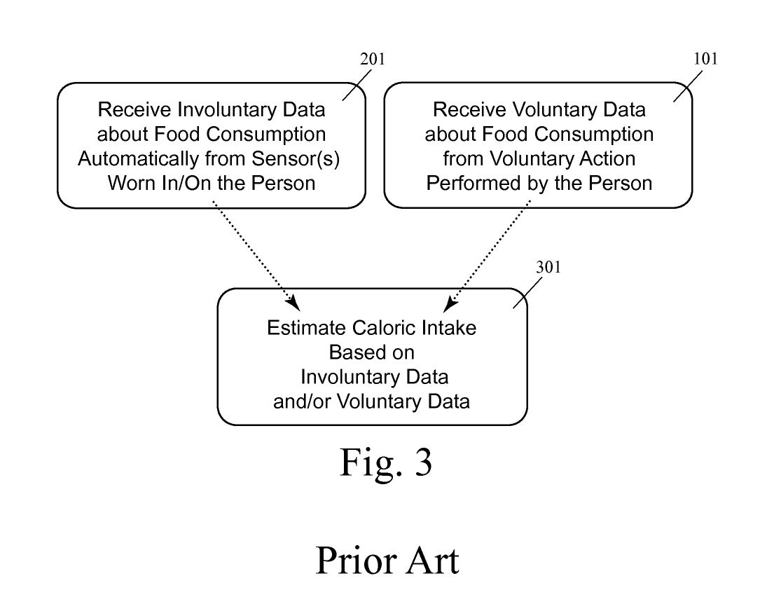

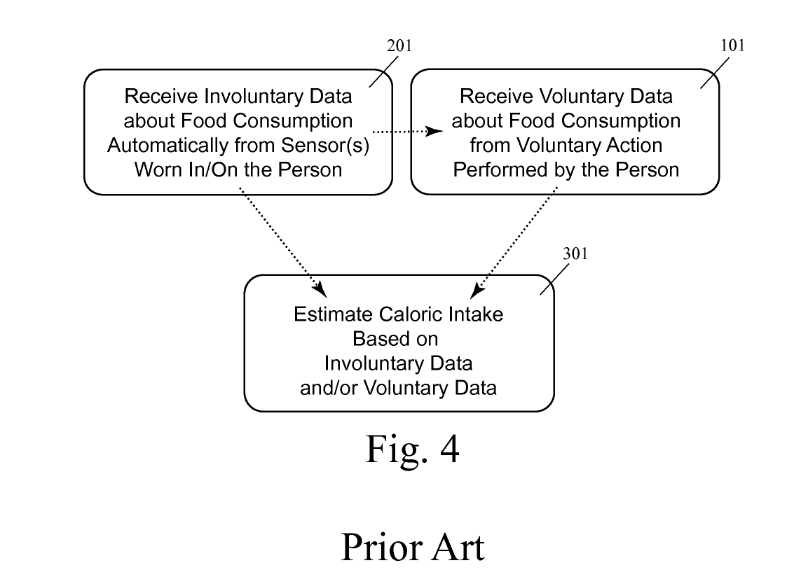

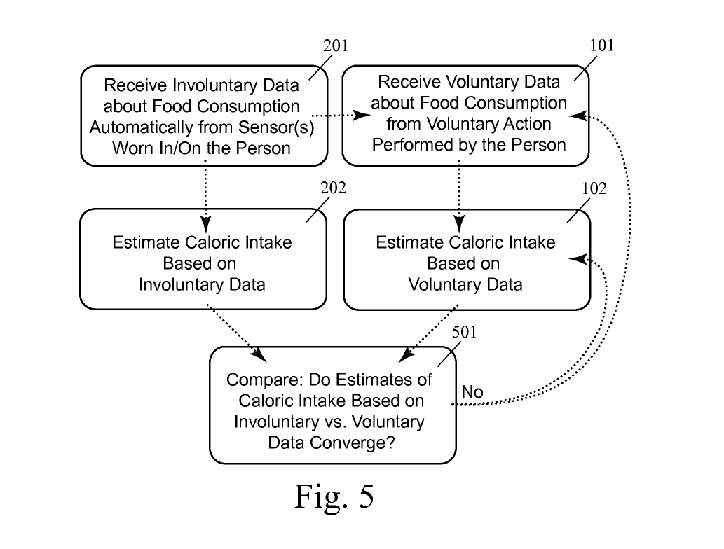

Figures showing embodiments of this invention begin with FIG. 5. The following figures, FIGS. 5 through 31, show various examples of how this invention may be embodied in a method and a device. However, these examples are not exhaustive and do not limit the full generalizability of the claims.

FIG. 5 shows an example of how this invention can be embodied in a five-step iterative method for measuring a person's food consumption and caloric intake. In this specification, food is broadly interpreted to include beverages and soft food, as well as solid food. In an example, this method can be performed with the assistance of one or more computing units or data processors. A computing unit may be incorporated into a wearable device, into a mobile device, or located in a remote location via data transmission means such as wireless communication or the internet. The method shown in FIG. 5 includes step 201 that comprises receiving involuntary data about the person's food consumption, in an automatic manner, from one or more sensors that are worn in or on the person. Involuntary data about food consumption is defined herein as data about food consumption that is received in an automatic manner that does not require any voluntary action by the person in association with an eating event, other than the actual action of eating. For example, if a camera worn on a person's wrist automatically records and analyzes images that indicate that the person is eating, then this would be involuntary data about food consumption. In another example, if a motion sensor worn on a person's wrist automatically records and analyzes motion data that indicates that the person is eating, then this would also be involuntary data about food consumption.

Involuntary data about food consumption is in contrast to voluntary data about food consumption. Voluntary data about a person's food consumption requires voluntary action by the person in association with an eating event, other than the actual action of eating. For example, if a person manually aims a digital and/or smart phone camera toward food which they are going to eat and then manually presses a button to take a picture of this food, then the resulting image is voluntary data about food consumption. In another example, maintaining a traditional diet log, recording food consumed by manual writing on paper, is another method of collecting voluntary data about food consumption. This latter method has been used for many decades.

Returning to our discussion of step 201 in FIG. 1, in various examples involuntary data about a person's food consumption can be collected automatically through one or more sensors. These one or more sensors can be selected from the group consisting of: accelerometer, inclinometer, other motion sensor, sound sensor, smell or olfactory sensor, blood pressure sensor, heart rate sensor, EEG sensor, ECG sensor, EMG sensor, electrical sensor, chemical sensor, gastric activity sensor, GPS sensor, camera or other image-creating sensor or device, optical sensor, piezoelectric sensor, respiration sensor, strain gauge, electrogoniometer, chewing sensor, swallow sensor, temperature sensor, and pressure sensor.

In an example, these one or more sensors can be worn on the person's body, either directly or worn on clothing. In various examples, these one or more sensors can be worn on the person's wrist, neck, ear, head, arm, finger, mouth or other locations on the person's body. In various examples, these one or more sensors can be worn in manner similar to that of a wrist watch, bracelet, necklace, pendant, button, belt, hearing aid, bluetooth device, ear ring, and/or finger ring. In other examples, these one or more sensors can be implanted within the person's body and may internally monitor chewing, swallowing, biting, other muscle activity, enzyme secretion, neural signals, or other ingestion-related processes or activities.

In an example, involuntary data can be analyzed to extract information about the types and quantities of food consumed. In various examples, involuntary data about food consumption can be analyzed by one or more methods selected from the group consisting of: pattern recognition or identification; human motion recognition or identification; facial recognition or identification; gesture recognition or identification; food recognition or identification; sound pattern recognition; Fourier transformation; chemical recognition or identification; smell recognition or identification; word recognition or identification; logo recognition or identification; bar code recognition or identification; and 3D modeling.

In various examples, involuntary data about food consumption can include information selected from the group consisting of: the types and volumes of food sources within view and/or reach of the person; changes in the volumes of these food sources over time; the number of times that the person brings their hand (with food) to their mouth; the sizes or portions of food that the person brings to their mouth; and the number, frequency, speed, or magnitude of chewing, biting, or swallowing movements.

In an example, one or more sensors may continually monitor the person to collect data about the person's food consumption. In various examples, one or more sensors may monitor sounds, motion, images, speed, geographic location, or other parameters. In other examples, one or more sensors may monitor parameters periodically, intermittently, or randomly. In other examples, the output of one type of sensor can be used to trigger operation of another type of sensor. In an example, a relatively less-intrusive sensor (such as a motion sensor) can be used to continually monitor the person and this less-intrusive sensor may trigger operation of a more-intrusive sensor (such as an imaging sensor) only when probable food consumption is detected by the less-intrusive sensor.

In various examples, some types of sensors and some modes of operation are more intrusive with respect to a person's privacy and/or time than other types of sensors and modes of operation. In an example, wearable motion sensors and sound sensors can be less intrusive than wearable imaging sensors. In an example, a wearable camera that records images within a narrow field of vision and a shorter focal length can be less intrusive than a wearable camera that records images with a wide field of vision and longer focal length. In an example, wearable sensors that operate only when triggered by a probable eating event are less intrusive than sensors than operate continuously. In an example, sensors that are worn under clothing or on less-prominent parts of the body are less intrusive than sensors that are worn on highly-visible portions of clothing or the body. In an example, sensors that allow a person to enter food consumption data a considerable time after a meal (delayed diet logging) are less intrusive than sensors that actively prompt a person to enter food consumption data right in the middle of a meal (real-time diet logging).

In the example that is shown in FIG. 5, the involuntary data about food consumption that is received in step 201 is subsequently used to estimate the person's caloric intake in step 202. In an example, the types and quantities of food consumed are explicitly identified in step 201. In other examples, the involuntary data collected in step 201 can be in a raw format that does not explicitly identify the types and quantities of food consumed. In this latter case, this raw data can be analyzed in step 202 to identify the types and quantities of food consumed as well as total caloric intake. In various examples, this analysis may include one or more methods selected from the group consisting of: food recognition or identification; visual pattern recognition or identification; human motion recognition or identification; chemical recognition or identification; smell recognition or identification; sound pattern recognition; word recognition or identification; logo recognition or identification; bar code recognition or identification; and 3D modeling.

In an example, information concerning the types and quantities of food consumed is used to estimate caloric intake in step 202. In an example, a standard database of the calories associated with various types of food, and portions thereof, can be used to convert information about the types and quantities of food consumed into an estimate of caloric intake in step 202. In another example, a customized database specific to an individual can be created based on the person's past eating habits. In an example, an estimate of caloric intake can be estimated directly from raw involuntary data received in step 201 without the need for an intermediate step involving identifying specific types and quantities of food consumed. In an example, an estimate of caloric intake can be for a particular eating event, such as a specific meal or snack. In another example, an estimate of caloric intake can be for a specific period of time such as a day, week, or month.

In an example, the estimation of caloric intake in step 202 can be largely, or entirely, automated. In an example, this estimation of caloric intake in step 202 can be done by a data processing device such as a computer. In an example, this estimation process can be performed within a device that is worn in or on a person. In another example, this estimation process can be performed in a mobile device that is carried by the person. In another example, this estimation process can be performed in a computer in a remote location, with data transferred back and forth between a wearable device and a computer in the remote location. In an example, data transferred between a wearable device and a computer in a remote location can be encrypted for the sake of privacy.

In an example, identification of the types and quantities of food consumed by a person can be done, in whole or in part, by using a standardized database that associates certain patterns of output from involuntary data sensors with consumption of certain types and quantities of food. In an example, estimation of the number of calories consumed by the person can be done, in whole or in part, by using a standardized database that associates certain types and quantities of food with certain calorie values.

In an example, identification of the types and quantities of food consumed by the person can be done, in whole or in part, by predicting a person's current eating patterns based on the person's historical eating patterns. For example, if the person tends to eat a particular type of food at a particular time of day in a particular location, then this can be taken into account when identifying food consumed. In an example, estimation of the number of calories consumed by the person can be done, in whole or in part, by predicting the calories associated with particular foods or meals based on the person's historical eating patterns. For example, if the person tends to consume larger-than-standard portions of a particular food, then this can be taken into account when estimating calories.

In the example shown in FIG. 5, voluntary data about food consumption is received from voluntary action performed by the person in step 101. As defined earlier, voluntary data about a person's food consumption is data that is received from voluntary actions performed by the person in association with eating events, other than the actual actions of eating. In various examples, voluntary action for recording food consumption can be selected from the group consisting of: writing on paper, typing on a keyboard, touching a touch screen, moving a cursor, speaking into a device with voice recognition capability, gesturing to a device with gesture recognition capability, manually scanning a bar code or other food code; and manually initiating the taking of a picture of food that will be consumed.

In an example, the voluntary data about food consumption that is received in step 101 can include precise information concerning the types and quantities of food consumed. In another example, voluntary data about food consumption received in step 101 may only include indirect raw data such as a picture of food, or general food categories, which must be subsequently analyzed in order to identify the types and quantities of food consumed. In an example, this voluntary data can be received by a computer and stored therein.

In the example shown in FIG. 5, voluntary data entry in step 101 can be independently initiated by the person before an eating event, during the eating event, or after the eating event. In another example, voluntary data collection in step 101 can be prompted or solicited based on the results of involuntary data collection in step 201. For example, involuntary data may suggest a high probability that the person is eating, which could trigger a request for voluntary data entry. The possibility that step 101 can be prompted by step 201 is represented by the dotted-line arrow from step 201 to step 101. In an example of how this prompt can be operationalized, a wearable sensor may detect a probable eating event in step 201 and this detection may prompt the person to enter voluntary data about the eating event, if any, in step 101.

In various examples, prompting or soliciting voluntary data collection in step 101 can be done using one or more methods selected from the group consisting of: a ring tone, a voice prompt, a musical prompt, an alarm, some other sound prompt, a text message, a phone call, a vibration or other tactile prompt, a mild electromagnetic stimulus, an image prompt, or activation of one or more lights. In various examples, some of these prompts are less intrusive with respect to the person's privacy and/or time, while other prompts are more intrusive with respect to the person's privacy and/or time—especially in social eating situations. In various examples, prompts that are less easily detected by other people are generally less intrusive in social eating settings.

In various examples, voluntary data concerning food consumption can be received in step 101 before, concurrently with, or after involuntary data is received in step 201. If the person initiates voluntary data about food consumption in step 101 before an eating event is detected via involuntary data collection in step 201, then prompting of voluntary data collection by step 201 is not needed. In an example, a person's initiating voluntary data about food consumption prior to an eating event, wherein this submission comprises accurate reporting of food to be consumed, is rewarded by enabling the person to avoid a more intrusive prompt for data during the eating event.

As shown in the embodiment of this invention in FIG. 5, voluntary data about food consumption from step 101 is used to estimate the person's caloric intake in step 102. In an example, the types and quantities of food consumed can be precisely identified in step 101, so that all that needs to be done in step 102 is to assign calorie values to each food portion consumed.

In another example, voluntary data from step 101 can be in a relatively raw form that requires analysis in step 102 in order to identify the types and quantities of food consumed. For example, the voluntary data from step 101 may comprise images of food consumed, without any accompanying explanation from the person. In various examples, analysis of voluntary data in step 102 may include one or more methods selected from the group consisting of: food image recognition or identification; word recognition or identification; logo recognition or identification; bar code recognition or identification; and 3D modeling.

In an example, estimation of the number of calories consumed by the person in step 102 can be done, in whole or in part, by using a standardized database that associates certain types and quantities of food with certain calorie values. In an example, estimation of the number of calories consumed by the person in step 102 can be done, in whole or in part, by predicting the calories associated with particular foods or meals based on the person's historical eating patterns. For example, if the person tends to consume large portions of a particular food, then this is taken into account when estimating calories.

In an example, the estimation process in step 102 may include automated pattern recognition and analysis of voluntarily-entered images in order to identify food types and quantities. In an example, a database of types of food (and portions) and their associated calories can be used to convert types and quantities of food into calories. In an example, the estimation of caloric intake in step 102 can be done by a data processing device such as a computer. In an example, an estimate of caloric intake can be made for a particular eating event such as a particular meal or snack. In an example, an estimate of caloric intake can be made for a particular period of time such as a day, week, or month. In various examples, estimation of caloric intake from voluntary data in step 102 can occur before, concurrently with, or after the estimation of caloric intake from involuntary data in step 202.

In the embodiment of this invention that is shown in FIG. 5, the estimate of caloric intake based on involuntary data from step 202 is compared in step 501 to the estimate of caloric intake based on voluntary data from 102. In an example, a determination is made in step 501 concerning whether these two estimates of caloric intake are sufficiently similar. In an example, a determination in made in step 501 concerning whether these two estimates of caloric intake are similar and/or converge. In an example, determination of sufficient similarity and/or convergence can be based on quantitative criteria for similarity and/or convergence. In an example, this comparison and determination of similarity and/or convergence can be done within a computer.

In an example, the criteria for similarity and/or convergence of these two estimates of caloric intake can be based on the absolute value of the difference in calories between these two estimates being less than a target number of calories. This target number can differ depending on the eating event or the time period for which the caloric intake is estimated. In another example, the criteria for similarity and/or convergence of these two estimates of caloric intake can be based on the percentage difference in calories between these two estimates being less than a target percentage.

In another example, the criteria for similarity and/or convergence of these two estimates of caloric intake can be based on projected mathematical and/or statistical models. For example, mathematical convergence can be identified based on a series of paired estimates from involuntary and voluntary data over time. In an example, paired estimates from involuntary and voluntary data over time can come from a series of cycles through some or all of the steps in FIG. 5. In this case, convergence criteria can be based on projected mathematical and/or statistical convergence of these two estimates. In another example, criteria for similarity and/or convergence of these two estimates can be based on overlapping statistical confidence intervals or statistical hypothesis testing.

In an example, the criteria for similarity and/or convergence of these two estimates can apply to individual eating events, such as individual meals or snacks. In an example, the criteria for similarity and/or convergence of these two estimates can apply to several events spread out over a period of time. In an example, the criteria for similarity and/or convergence can apply to summary statistics spanning multiple eating events in manner that allows for some degree of variation and outliers, as long as long-term accuracy is maintained.

In an example, the person can be allowed to temporarily adjust the criteria for similarity and/or convergence. In another example, the person can be allowed to permanently adjust the criteria for similarity and/or convergence. In an example, the person's ability to adjust the criteria for similarity and/or convergence can depend on the degree of historical convergence of estimates from involuntary and voluntary data. In an example, the person can be given more control over adjustment of the convergence criteria as a reward for a history of accurately reporting voluntary data about food consumption and/or achievement of energy balance goals.

If the estimate of caloric intake from the involuntary data from step 202 and the estimate of caloric intake from voluntary data from step 102, in combination, meet the criteria for similarity and/or convergence in step 501, then the method shown in FIG. 5 can conclude after this comparison is done. If these estimates do not meet these criteria for similarity and/or convergence, then more information is required. In the case shown in FIG. 5, more information is collected by having the method cycle back to repeat steps 101 and/or 102, in repeated cycles, until the similarity and/or convergence criteria are met. Cycling back to steps 101 and/or 102 is represented by dotted line arrows from step 501 back up to steps 101 and 102.

In an example, if the similarity and/or convergence criteria are not met in step 501, then the person is prompted to provide additional voluntary data concerning food consumption in a repeat of step 101. In an example, this additional voluntary data can be similar in nature, but more detailed or broader in scope, than the data that was originally received in step 101. For example, if the data that the person entered the first time in step 101 was a brief natural-language phrase concerning food consumed (that the person entered into a device), then additional data in the second sub-cycle could comprise a detailed and structured (menu-driven) interface. In another example, this additional voluntary data could be quite different in nature. For example, if the data that the person entered the first time in step 101 was a brief verbal description of food, then additional data in the second sub-cycle could be a manually-taken picture of food.

In another example, if similarity and/or convergence criteria are not met in step 501, then the estimation process or estimation model in step 102 may be modified. In an example, the relative weights given to different data elements in the estimation process or the structure of the estimation model may be modified. In an example, the relative weights given to historical vs. current data in an estimation model may be adjusted. In an example, modification of the estimation process may use Bayesian statistical methods. In an example, modification of the estimation process may use nonlinear mathematical programming or optimization methods. In an example, modification of the estimation process may include goal-directed changes. In an example, modification of the estimation process may include randomized, non-goal-directed changes.

In various examples, if similarity and/or convergence criteria are not met in step 501, then the person may be prompted for additional data in a return to step 101, the estimation process may be modified in a return to step 102, or both steps 101 and 102 may be revisited. In this manner, a new estimate of caloric intake, one that is based on more-complete voluntary data, is created. The possibility of returning to steps 101 and/or 102 creates a potentially-repeating sub-cycle of steps 101, 102, and 501 in this method. In an example, this sub-cycle can repeat indefinitely until the caloric intake estimate from involuntary data and the caloric intake estimate from voluntary data meet the criteria for similarity and/or convergence. Alternatively, there can be a limit on how many times this sub-cycle repeats before it stops, regardless of whether the criteria for similarity and/or convergence have been met.

In the method shown in FIG. 5, the similarity and/or convergence of the caloric intake estimates from involuntary data and voluntary data functions as a proxy for data accuracy. However, even in the case wherein estimates of caloric intake based on involuntary data are consistently more accurate than estimates of caloric intake based on voluntary data, this method may be superior to estimating caloric intake based on involuntary data alone. Even if estimates from voluntary data are redundant or inferior to estimates from involuntary data, there are psychological and motivational benefits to engaging someone in managing their own energy balance and weight. The method shown in FIG. 5 can achieve the benefits of such engagement, while minimizing intrusion into the person's privacy and/or time.

The embodiment of this invention that is shown in FIG. 5 gives the person incentives to provide accurate and timely voluntary data concerning food consumption in step 101. In an example, the person can provide such voluntary data in step 101 first, before the automated detection of a likely eating event in step 201. In another example, accurate voluntary data can be provided when such data is prompted by automated detection of a likely eating event in step 201. In an example, if accurate and timely data concerning food consumption is not provided at first, then the person will be prompted to provide it when the estimates of caloric intake from involuntary and voluntary data fail to converge in step 501.

This method provides the person with multiple incentives to provide both accurate and timely voluntary data. One such incentive is the avoidance of increasingly-intrusive data collection methods in subsequent sub-cycles of steps 101, 102, and 501. As the person becomes more engaged and accurate with respect to voluntary reporting of caloric intake, involuntary data collection becomes less necessary and less intrusive.

Involuntary data and voluntary data generally have different strengths and weaknesses with respect to estimating caloric intake. Involuntary data in which sensors automatically monitor a person's behavior and surrounding space for eating events can be great for compliance and automated analysis of portion size, but can be intrusive. Voluntary data in which a person uses all of their senses to identify food consumed can be great for accuracy and privacy when the person is 100% compliant with reporting, but 100% long-term compliance with manual diet logging is rare. Combining both involuntary and voluntary data collection, in an optimal manner driven by empirical convergence of estimates (as shown in the method given in FIG. 5) can provide more accurate measurement of caloric intake than either involuntary data alone or voluntary data alone.

For example, on the one hand, a motion sensor that collects involuntary data concerning hand motion can accurately detect that a person is eating “something” each time that the person eats, but may not be able to accurately identify exactly what the person is eating. On the other hand, a person can accurately detect what they are eating each time that they eat, but they may forget to enter the eating event or may intentionally omit the eating event in the food log (in an passive act of denial).

A system in which a person is prompted by a motion sensor to enter what they eat (each time that they eat) can provide a more accurate measurement of caloric intake than either involuntary data from a motion sensor alone or voluntary data from manual diet logging alone. The method in FIG. 5 takes this concept even further. Additional voluntary data is collected until the two estimates of caloric intake meet the criteria for similarity and/or convergence. This provides the person with incentives for both timeliness and accuracy in voluntary data reporting of food consumption. It also actively engages the person in managing their own energy balance.

Entirely-voluntary systems for tracking food consumption are generally oblivious concerning skipped or inaccurate food consumption log entries. When a person has a snack and does not enter it into the log, then that is the end of the story. The log is a passive data collector, not an intelligent and interactive data-collecting agent. The method that is shown in FIG. 5 corrects this problem. Skipped or inaccurate voluntary data concerning food consumption triggers escalation in data collection. If the person does not provide accurate and timely information concerning an eating event, then this method cycles back to prompt them until they do so.

By way of a colorful analogy, this method and system for ensuring accurate measurement of caloric intake may be compared to the ridges in highway pavement along the sides of some roads that help to keep a person from driving their car off the road. If a driver stays alert and accurately stays within their lane, then they never encounter the ridges and may not even be aware of the ridges. However, if a driver becomes drowsy (or distracted) and begins to drift off the road, then their car tires hit the ridges, which creates a loud rumbling noise. This alerts the driver to correctively steer and get back on the road. While it is true that the noise of the tires on the ridges is intrusive (and potentially annoying), it serves an important purpose. It helps to keep the driver on the road, can prevent injury, and may even prevent death.

In an analogous manner to road ridges which help keep a driver safely on the road, the caloric intake method and system shown in FIG. 5 helps to keep a person “on the road” to proper energy balance. When the person promptly and accurately records food consumed, then this caloric intake measuring method and system is minimally intrusive. The collection of involuntary data may even become completely transparent to the person. However, if the person begins to figuratively “drift off the road” of energy balance (by not recording snacks or by entering inaccurate information concerning meals), then the system figuratively “creates a noise” to get the person back on track. While a secondary sub-cycle of data collection can be more intrusive (or even potentially annoying), it serves an important purpose. It helps the person to better track their caloric intake, to maintain energy balance, and to prevent the negative health outcomes associated with obesity.

Systems and methods for tracking food consumption which rely entirely on involuntary data collection do not engage the person in managing their own energy balance and weight. The method in FIG. 5 does not suffer from this limitation. This method, including convergence criteria, encourages the person to work together with automated sensors in order to track and manage their own caloric intake, maintain proper energy balance, and make progress toward their weight goals.

There are systems and methods in the prior art that use a fixed blend of involuntary and voluntary data to estimate caloric intake. These systems can be superior to those that depend on voluntary data alone, but even these systems do not minimize intrusion of the person's privacy and/or time in the achievement of a desired level of caloric intake measurement accuracy. The optimal blend of involuntary and voluntary data for estimating caloric intake can vary between individuals. It can also vary over time for the same individual. Real-time adjustment of the blend of involuntary and voluntary data is required to find the optimal blend that achieves desired accuracy with minimal intrusion into the person's privacy and/or time. The method in FIG. 5 corrects this problem. The method in FIG. 5 uses interactive adjustments and convergence criteria to achieve the desired level of accuracy in measuring caloric intake while minimizing intrusion into the person's privacy and/or time.

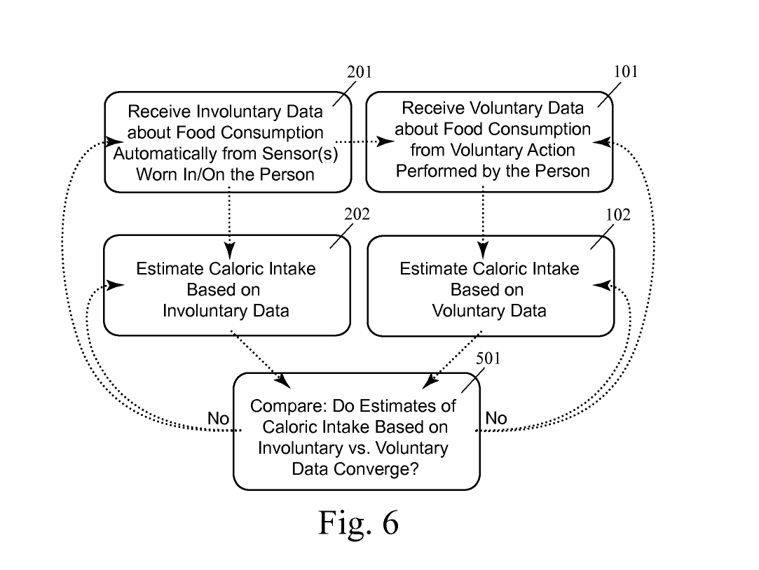

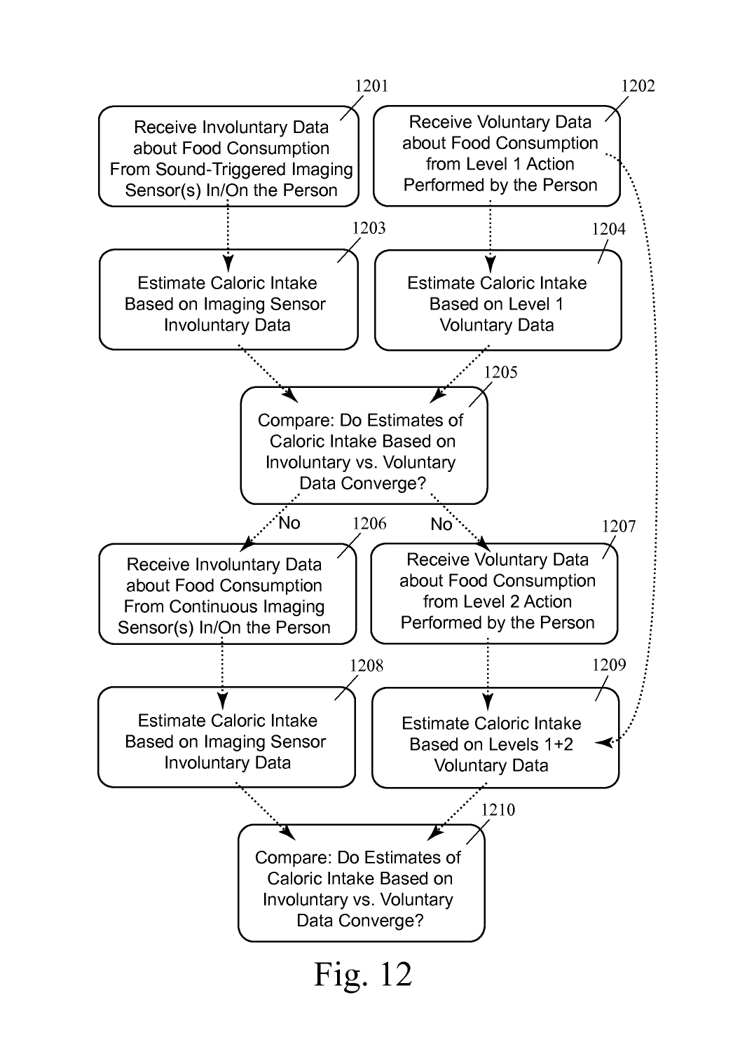

The next set of figures in this disclosure includes FIGS. 6 through 12. FIGS. 6 through 12 show additional examples of how this invention can be embodied, wherein these additional examples are variations on the method introduced in FIG. 5. The methods shown in FIGS. 6 through 12 all include collection of both involuntary data and voluntary data concerning food consumption, calculating and comparing estimates of caloric intake from these two data sources, and collecting additional information if the criteria for similarity and/or convergence of these two estimates are not met. Further, the examples in FIGS. 6 through 12 provide greater specificity with respect to what types of data and what types of sensors are used for data collection in a first data-collection cycle vs. subsequent data-collection cycles. All of the examples shown in FIGS. 6 through 12 also implicitly assume that the similarity and/or convergence of estimates from two data sources can function as a proxy for estimation accuracy. We will relax this assumption later in the examples shown after FIG. 12. We now discuss FIGS. 6 through 12 in detail.

FIG. 6 shows another example of how this invention can be embodied in a method for measuring caloric intake. The example in FIG. 6 is like the example in FIG. 5, except that it also includes a sub-cycle that collects additional involuntary data in the event that the estimates of caloric intake based on involuntary data and voluntary data do not meet the criteria for similarity and/or convergence. This is represented by the dotted-line arrows from step 501 back to steps 201 and 202. In FIG. 6, the lack of similarity and/or convergence prompts collection of additional involuntary data as well as additional voluntary data.

In an example, the collection of additional involuntary data in a second sub-cycle, in the event of non-convergence of estimates, is more intrusive (but also more accurate) than the collection of involuntary data a first sub-cycle. In an example, the nature of the additional involuntary data may be the same as the original involuntary data, but in greater detail. For example, the original involuntary data can be periodic, short-focal-length images from an imaging sensor worn by the person, but the additional involuntary data may be continuous, variable-focal-length images from the imaging sensor. In another example, the nature of the additional involuntary data may be different than that of the original involuntary data. For example, the original involuntary data may be motion patterns collected from a motion sensor worn by the person, but the additional involuntary data may be sound patterns from a sound sensor worn by the person.

In an example, the scope and depth of involuntary and voluntary data collection may be escalated until the two estimates of caloric intake based on involuntary data vs. voluntary data meet the criteria for similarity and/or convergence. In an example, similarity criteria can be used for a single pair of estimates and convergence criteria can be used for a time series of estimate pairs. While such escalation may sound harsh, the result is a system and method that is less intrusive than a system and method that always operates at a high level of intrusiveness regardless of the relative accuracy or convergence of estimates based on involuntary and voluntary data. As was the case in FIG. 5, convergence of estimates from involuntary and voluntary data functions as a proxy for accuracy.

Comparing the methods shown in FIG. 5 vs. FIG. 6, the method in FIG. 5 relies more on the accuracy of estimates from involuntary data, while the method in FIG. 6 is relatively-neutral with respect to the assumed relative accuracy of estimates from involuntary and voluntary data. Both methods implicitly assume that similarity and/or convergence of estimates from different sources can be used as a proxy for accuracy. Both methods engage the person in monitoring their caloric intake, which can be a key component of an overall system for energy balance and weight management.

In an example, steps 202 and 102 can occur in a simultaneous or parallel manner. In the event that the two estimates do not meet the criteria for similarity and/or convergence, the second iterations back to steps 201 and 202 and back to steps 101 and 102 can also occur simultaneously and in parallel. In another example, steps 202 and 102 can occur in a sequential or alternating manner. In the latter case, iteration back to steps 201 and 202 can occur in a sequential or alternating manner with iteration back to steps 101 and 102.

In an example, the ratio of iterations back to 201 and 202 vs. back to 101 and 102 need not be one-to-one. In an example, there may be multiple iterations back to 201 and 202 as compared to back to 101 and 102, or vice versa, depending on changes or convergence patterns in their respective caloric intake estimates. In an example, there may be relatively more iterations in involuntary data collection when estimated caloric intake values from involuntary data from successive cycles display significant changes with additional data collection. On the other hand, there may be relatively fewer iterations in involuntary data collection when estimated caloric intake values from involuntary data from successive cycles do not display significant changes with additional data collection.

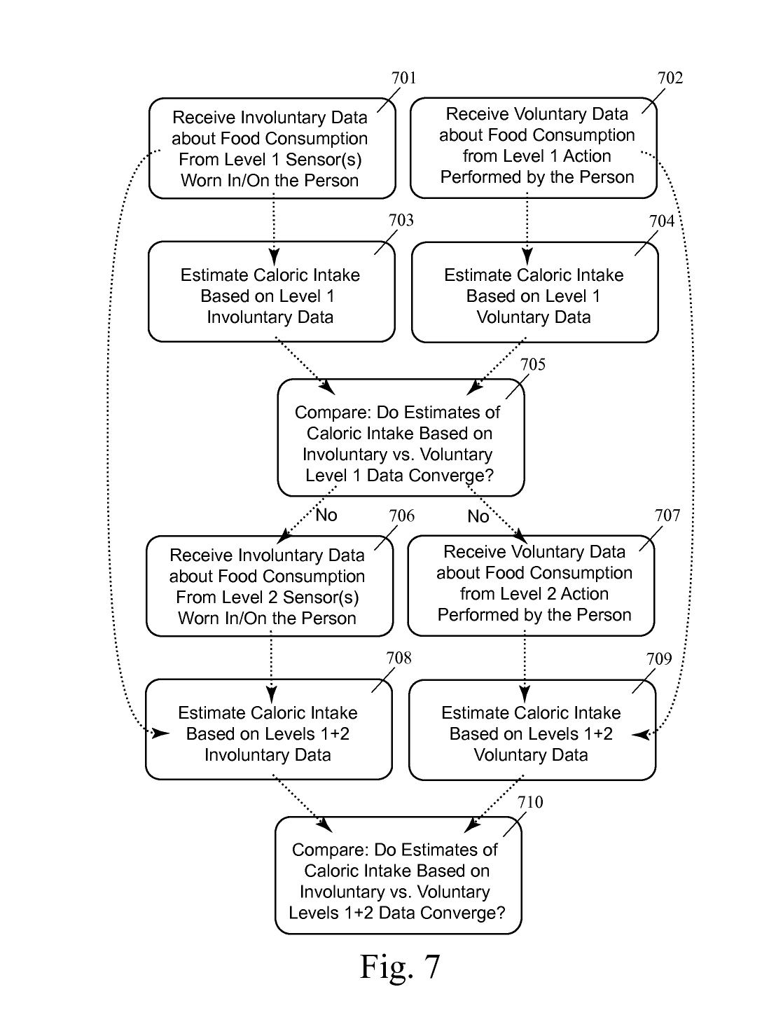

FIG. 7 shows another example of how this invention can be embodied in a method to measure a person's caloric intake. The example shown in FIG. 7 is similar to that shown in FIG. 6, except that: (a) FIG. 7 shows greater specificity about the different levels of sensors used to collect involuntary data and the different levels of actions used to record voluntary data; and (b) FIG. 7 explicitly limits the number of data collection sub-cycles to a maximum of two.

In an example, “level 1” wearable sensors in FIG. 7 can be relatively less-intrusive because of their low-level modality (e.g. motion and sound), non-continuous operation (e.g. only when triggered by a probable eating event), low-profile placement (e.g. under clothing), and/or flexible timing (e.g. delayed data acquisition after multiple eating events). In an example, “level 2” wearable sensors in FIG. 7 can be more-intrusive because of their high-level modality (e.g. images), continuous operation, high-profile placement (e.g. around the person's neck), and/or immediate timing (e.g. real time data acquisition during eating events).

The method in FIG. 7 also differs from that in FIG. 6 in that it explicitly shows only two cycles of data collection when intake estimates based on involuntary and voluntary data do not meet the criteria for similarity and/or convergence. The first cycle of data collection, shown in the upper half of FIG. 7, comprises receiving involuntary data about food consumption from one or more “level 1” sensors worn in or on the person in step 701. Data from step 701 is then used to estimate caloric intake in step 703. This first cycle of data collection also comprises receiving voluntary data about food consumption from one or more “level 1” actions performed by the person in step 702. Data from step 702 is then used to estimate caloric intake in step 704.

In FIG. 7, if the two estimates of caloric intake from steps 703 and 704, based on involuntary data and voluntary data respectively, meet the criteria for similarity and/or convergence in step 705, then the method is concluded after this comparison. The second cycle of data collection, shown on the bottom half of FIG. 7, does not occur. However, if the estimates of caloric intake from steps 703 and 704 do not meet the criteria for similarity and/or convergence in step 705, then the method continues to steps 706 and 707 in a second cycle of data collection.

The second cycle of data collection, shown in the lower half of FIG. 7, commences with: receiving involuntary data about food consumption from one or more “level 2” sensors worn in or on the person in step 706; and receiving voluntary data about food consumption from one or more “level 2” actions performed by the person in step 707. In an example, “level 2” sensors can be more intrusive than “level 1” sensors, but can also provide more accurate information for estimating caloric intake. In an example, “level 2” actions can be more intrusive and/or time-consuming than “level 1” actions, but can also provide more accurate information for estimating caloric intake.

In an example, a “level 1” sensor can be a wearable motion sensor or sound sensor and a “level 2” sensor can be a wearable camera or other image-creating sensor.

In another example, a “level 1” sensor can be a wearable camera with a narrow field of view and a short-range focus and a “level 2” sensor can be a wearable camera with a wide field of view and a variable-range focus. In an example, a “level 1” sensor can be a wearable camera that only takes pictures when a motion or sound sensor suggests that an eating event is occurring and a “level 2” sensor can be a wearable camera that takes pictures continuously. In an example, a “level 1” sensor can be a wearable camera that only takes pictures at a certain time of day, or in a certain GPS-indicated location, that suggests that the person may be eating, and a “level 2” camera can take pictures continuously.

In an example, a “level 1” action can comprise manually entering a phrase to describe food into a mobile device and a “level 2” action can comprise manually taking (e.g. “pointing and shooting”) a picture of food. In another example, a “level 1” action can be manually entering (at the end of the day) information on food that was consumed during the day at a private moment, but a “level 2” action may be entering information about food consumed in real time during each eating event. In an example, a “level 1” action can be responding to a quiet vibration from a wearable device by entering data on food consumed, but a “level 2” action can be responding to full-volume voice inquiry from a wearable device.

In various examples, collection of “level 2” voluntary data can be more-intrusive, offer less flexibility, and be more time-consuming than collection of “level 1” data. In an example, “level 1” voluntary data collection may allow considerable flexibility in terms of whether food consumption entries are made before, during, or after eating. Level 2 voluntary data collection may offer less flexibility in timing For example, “level 2” data collection may require real-time reporting for maximum accuracy. If the person wants to eat in peace without dealing with real-time data prompts, then they have a strong incentive to provide accurate voluntary data concerning food consumption in the first data collection cycle.

The second cycle of data collection, shown in the bottom half of in FIG. 7, continues in step 708 with estimation of caloric intake based on cumulative involuntary data from “level 1” and “level 2” sensors and in step 709 with estimation of caloric intake based on cumulative voluntary data from “level 1” and “level 2” actions. Analytic methods such as those discussed for the embodiments in FIGS. 5 and 6 may also be used in steps 708 and 709 in FIG. 7. FIG. 7 is more explicit than FIGS. 5 and 6 with respect to the use of cumulative data from both the first and second collection cycles when making estimates in the second cycle. In an example, information from the first and second data collection cycles can be combined using Bayesian statistical methods, with data from the first data collection cycle functioning as prior values.

The method disclosed in FIG. 7 concludes with the comparison in step 710 of caloric intake estimates from steps 708 and 709. In various examples, the criteria for similarity and/or convergence of caloric intake estimates can be similar to those discussed for FIGS. 5 and 6. The method and system shown in FIG. 7 differs from those shown in FIGS. 5 and 6 in that FIG. 7 shows a finite number of data collection sub-cycles. In FIG. 7, there is a maximum of two data collection cycles; the first occurs in the upper half of FIG. 7 and the second occurs in the bottom half of FIG. 7. In other examples, there may be a higher maximum number of data collection cycles, such as three or more, with an explicit progression of increasingly-intrusive data collection methods until similarity and/or convergence of estimates is achieved.

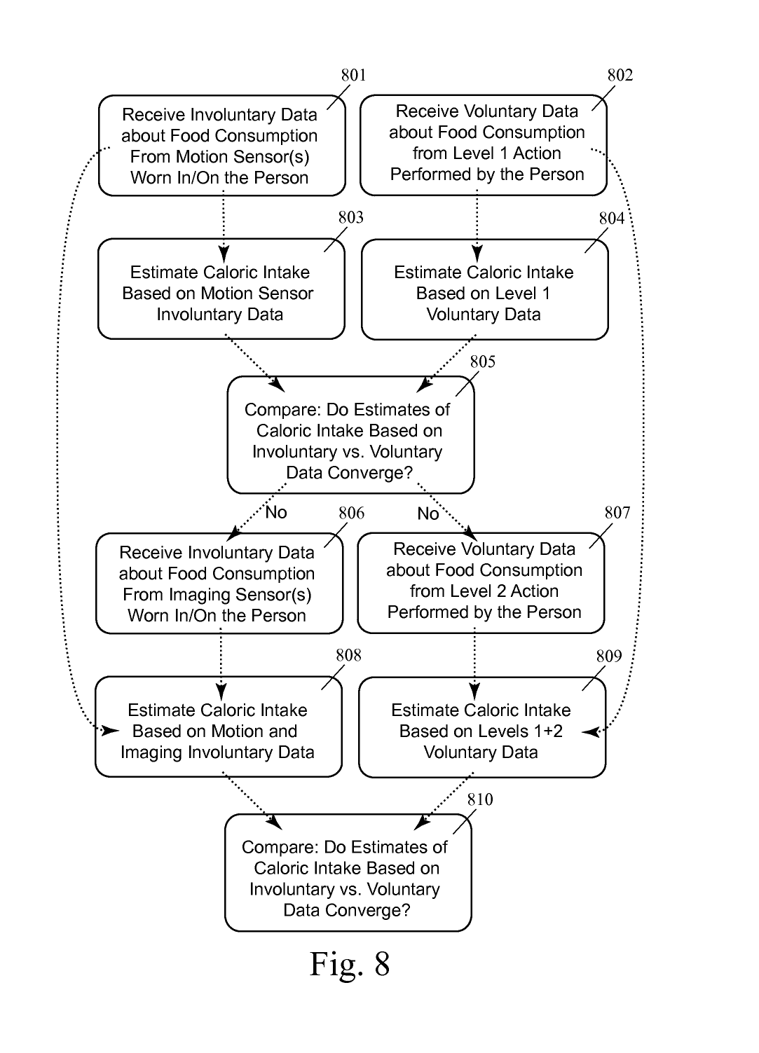

FIG. 8 shows another example of how this invention may be embodied in a method and system to measure a person's caloric intake. This example is similar to that shown in FIG. 7 in that it has a maximum of two sub-cycles of data collection and the second cycle is only triggered if the estimates from the first cycle do not meet the criteria for similarity and/or convergence. However, FIG. 8 differs from FIG. 7 in that the types or modes of sensors that are used to collect involuntary data are explicitly specified. In FIG. 8, the less-intrusive (and presumably less-accurate) “level 1” sensor is specified as a wearable motion sensor.

In an example, a wearable motion sensor may be a three-dimensional accelerometer that is incorporated into a device that the person wears on their wrist, in a manner like a wrist watch. In an example, this three-dimensional accelerometer may detect probable eating events based on monitoring and analysis of the three-dimensional movement of the person's arm and hand. Eating activity may be indicated by particular patterns of up and down, rolling and pitching, movements. Although a continuously-monitoring motion sensor could be viewed as intrusive to some extent, it is likely to intrude much less on the person's privacy that would a continuously-monitoring wearable microphone or wearable camera. Thus, it can be a good choice for a “level 1” sensor.

In FIG. 8, the more-intrusive (and presumably more-accurate) “level 2” sensor is specified as a wearable imaging sensor. In an example, a wearable imaging sensor may be a camera that is part of a device that the person wears on their wrist, in a manner like a wrist watch. In an example, this camera may be directed toward the person's fingers to identify food which the person reaches for, grasps, holds, and consumes during eating activities. In various examples, this food may be on a plate, on a shelf, in a bag, in a glass, on a table, or otherwise within viewing (and reaching) distance of the person. In another example, a camera may be worn on the person's neck in a manner like a necklace, incorporated into a button worn on clothing, or incorporated into a finger or ear ring. In an example, the focal direction and focal range of such a wearable camera can be chosen so as to capture images of food consumed, while minimizing privacy-intruding images. In an example, pattern recognition can be used to automatically blur out privacy-intruding images (such as images of other people) by adjusting focal range in real time.

In an example, images of food can be taken by mobile devices that are carried by, but not worn on, the person. However, it is difficult to ensure involuntary data collection by a device that is not worn by the person. The person might forget to bring the device to a meal. The person might hide the device in a location where it does not record eating activity. The person might unintentionally place the device in a location, or pointed in a direction, that does not capture eating activity. In an example, a smartphone “ap” that can be used to take pictures of food can be useful for tracking caloric intake, but not if it is left in a purse, left at home, or simply pointed in the wrong direction. For these reasons, a wearable sensor is preferable for involuntary data collection.

While is still possible for a person to tamper with, and impair, the operation of a wearable sensor, anti-tampering features can be more easily incorporated into the design a wearable device than a non-wearable device. For example, a wearable sensor may trigger an alarm, or other response, if it removed from contact with the person's skin. Skin contact can be monitored using electromagnetic, pressure, motion, and/or sound sensors. In an example, a wearable motion sensor may trigger an alarm, or other response, if there is a lack of motion that is not also accompanied by specific indications of sleeping activity. In an example, a wearable sound sensor may trigger an alarm or other response if there is a lack of sounds (such as pulse or respiration) that are normally associated with proximity to the person's body. In an example, a wearable imaging sensor may trigger an alarm, or other response, if there is a lack of images (such as a view of the person's hand or face identified by recognition software) that are associated with proper positioning on the person's body.

Turning to the voluntary action side of FIG. 8, “level 2” actions are more intrusive into the person's privacy and/or time than are “level 1” actions. Level 2 actions give the person less flexibility with respect to data entry structure, timing, and precision; and are less discrete with respect to the data entry interface. For these reasons, the person has an incentive to be engaged and record timely and accurate data concerning food consumption in “level 1” data collection in order to avoid the intrusiveness of “level 2” data collection. As discussed earlier in the analogy to road ridges (which can be annoying, but can save lives), the escalating intrusiveness of “level 2” actions could also be viewed as “annoying.” However, in the long-run, it can be far less “annoying” than the many negative health outcomes of obesity or the health risks of invasive stomach-altering surgery.

The exact types of less-intrusive voluntary actions performed by the person for recording “level 1” voluntary data and the exact types of more-intrusive voluntary actions performed by the person for recording “level 2” voluntary data are not specified in FIG. 8. There are a variety of voluntary actions to record voluntary data concerning food consumption that are discussed in the prior art and the precise specification of action type is not central to this embodiment. Further, there can be considerably more variability within a given type of voluntary action (as compared to a given type of involuntary sensor data) due to the variability in human compliance. For example, there is a wide variety of open-ended or menu-driven human-computer interfaces which can be used for voluntary data collection. In various examples, this interface can comprise a touch screen, voice commands and recognition, key pad, gesture recognition, eye movements, or a variety of other modes of human-computer interaction. Accordingly, the specific types of actions used in “level 1” and “level 2” voluntary data collection are not specified in this example,

The top half of the method and system for measuring caloric intake that is shown in FIG. 8 starts with: (a) the receipt of involuntary data about food consumption, from one or more motion sensors that are worn in or on the person, in step 801; and (b) the receipt of voluntary data about food consumption, from one or more “level 1” actions performed by the person, in step 802. In the steps that follow, caloric intake is estimated in step 803 based on data from the wearable motion sensor and caloric intake is estimated in step 804 based on data from “level 1” voluntary action performed by the person. Then, in step 805, these two estimates of caloric intake, one based on involuntary data and one based on voluntary data, are compared to determine whether they meet the criteria for similarity and/or convergence. The criteria for similarity and/convergence can be selected from among those that were discussed in previous examples.

If the estimates of the person's caloric intake from steps 803 and 804 meet the criteria for similarity and/or convergence in step 805, then the method in FIG. 8 concludes and steps 806 through 810 shown in the bottom half of FIG. 8 are not required. If the estimates of caloric intake from steps 803 and 804 do not meet the criteria for similarity and/or convergence in step 805, then this method continues with a second round of additional data collection and caloric intake estimation. This second round is shown in the bottom half of FIG. 8. If these estimates of caloric intake do not converge in step 805, then: involuntary data about food consumption is received from one or more imaging sensors that are worn in or on the person in step 806; and voluntary data about food consumption is received from one or more “level 2” actions performed by the person in step 807.

In the event that the estimates do not meet criteria for similarity and/or convergence in step 805, then in step 808 an estimate of the person's caloric intake is determined based on cumulative involuntary data from both motion sensors and imaging sensors. Also, in step 809, an estimate of the person's caloric intake is determined based on cumulative voluntary data from both “level 1” and “level 2” actions. Finally, in step 810, the estimates of the person's caloric intake from steps 808 and 809, one based on involuntary data and one based on voluntary data, are compared to determine whether they meet the criteria for similarity and/or convergence. The criteria for similarity and/convergence can be those discussed for previous figures.

In an example, the collection and use of additional involuntary data (steps 806 and 808) and additional voluntary data (steps 807 and 809) can be done in parallel. In an example, collection of these two types of data can be done in an alternating manner or in a series. In an example, the collection of additional involuntary data and additional voluntary data can be done in a one-to-one correspondence. In another example, it can be done a many-to-one correspondence. In an example, the type of data (involuntary or voluntary) whose latest augmentation most contributes to the similarity and/or convergence of caloric intake estimates can be disproportionately selected for additional data collection.

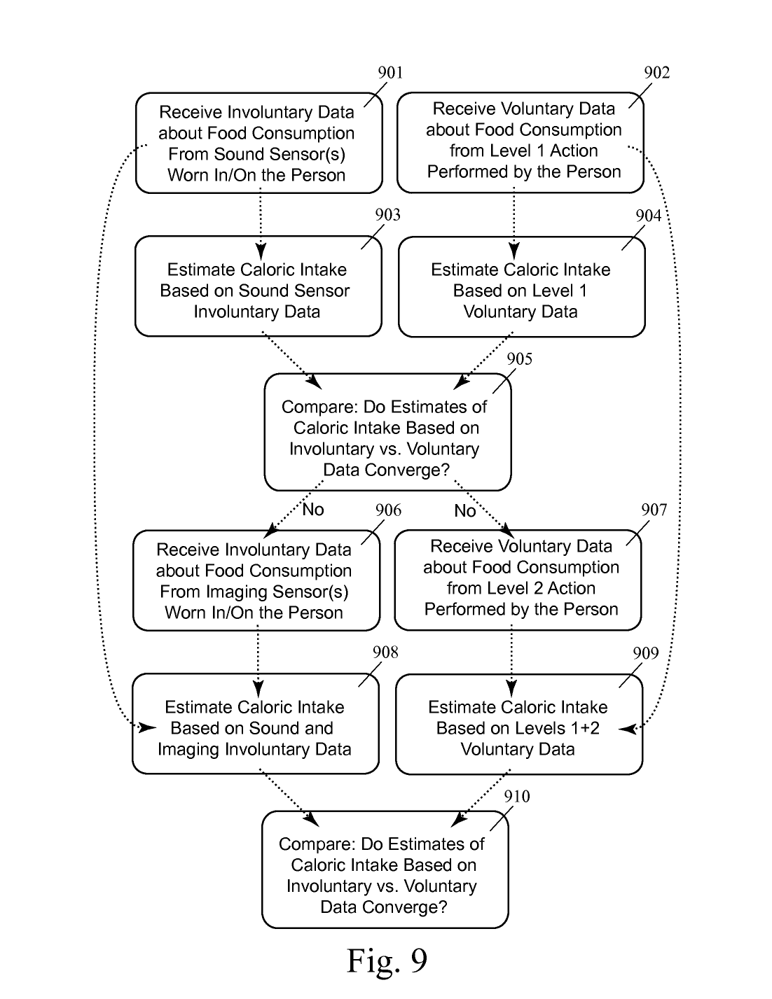

FIG. 9 shows an example of this invention that is similar to that shown in FIG. 8 except that it specifies a different modality of less-intrusive sensor for the first-round of involuntary data collection. In FIG. 9, in steps 901, 903, and 908, a wearable sound sensor is used (in contrast to the wearable motion sensor in FIG. 8). In an example, a sound sensor can be more intrusive than a motion sensor with respect to possibly recording conversations or other sounds that could intrude on privacy, but is not as intrusive as an imaging sensor with respect to possibly recording people or other images that could intrude on privacy. In an example, speech recognition software could be used to explicitly filter out the recording of human speech in the interest of privacy, while still recording chewing, biting, and swallowing sounds in order to identify the types and quantities of food consumed.

In an example, a wearable sound sensor can be worn around the neck like a necklace. In an example, a wearable sound sensor can detect chewing, biting, or swallowing sounds that indicate a probable eating activity. This detection can be through direct contact with the body or through chewing, biting, or swallowing sounds traveling through the air. In another example, a sound sensor can be worn behind the ear. In another example, a wearable sound sensor can be worn under clothing in a manner that is less conspicuous than a wearable imaging sensor.

In an example, the same sound sensor may be used for both involuntary and voluntary data collection. In an example, the same sound sensor may also be used to receive voice messages from the person. It can also serve as the hardware embodiment for receiving voluntary data in steps 902 and 907. The other numbered steps in FIG. 9 have descriptions and functions that are similar to their counterparts in FIG. 8 (with step numbers that have the same last two digits—for example step 907 in FIG. 9 corresponding to step 807 in FIG. 8), so it is not necessary to repeat the descriptions and functions of those steps here.

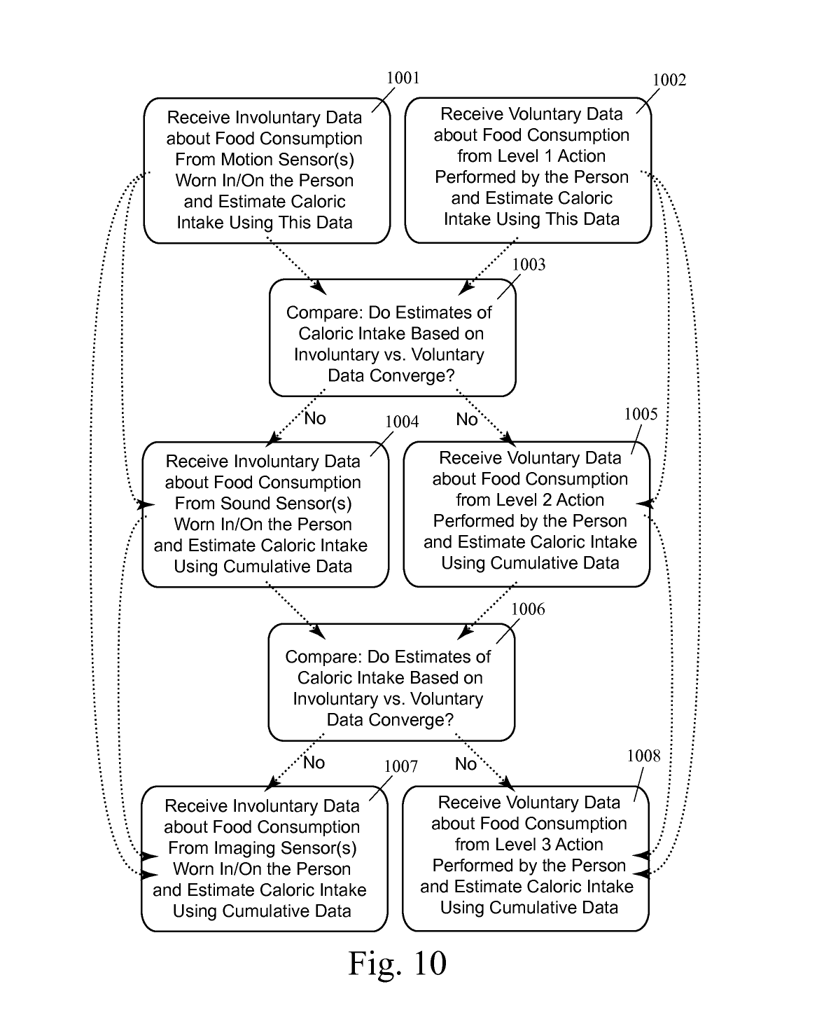

FIG. 10 shows another example of how this invention can be embodied. FIG. 10 shows a method and system for measuring a person's caloric intake that includes up to three cycles of data collection and explicitly specifies three types (modalities) of involuntary data sensors. In some respects, the method that is shown in FIG. 10 links together, in series, the sensor modality progressions that were previously-specified in FIGS. 8 and 9. The three-cycle method in FIG. 10 escalates, as needed, from motion sensors to sound sensors to imaging sensors. If similarity and/or convergence criteria are met in any given cycle (e.g. at step 1003, or 1006), then the method comes to a stop. If the similarity and/or convergence criteria are not met, then the method escalates to the next data collection cycle, up to a maximum of three cycles. In the method for caloric intake measurement that is shown in FIG. 10, as well as the methods shown in prior FIGS. 5 through 9, the similarity and/or convergence of caloric estimates from involuntary and voluntary data functions as a proxy for estimation accuracy.

We now discuss FIG. 10 in detail. The first data collection cycle in FIG. 10, shown in the upper three steps, comprises: (a) step 1001 in which involuntary data about food consumption is received from motion sensors that are worn in or on the person and this data is used to estimate caloric intake; (b) step 1002 in which voluntary data about food consumption is received from “level 1” actions performed by the person and this data used to estimate caloric intake; and (c) step 1003 in which these two estimates are compared to determined whether they meet the criteria for similarity and/or convergence. If these criteria are met, then the method stops and the person is only engaged with less-intrusive motion sensors and “level 1” actions.

If the criteria for similarity and/or convergence are not met in step 1003, then the method in FIG. 10 escalates to a second cycle of more-intrusive collection of additional involuntary and voluntary data about food consumption. The second cycle is shown in the third and fourth rows of steps in FIG. 10. This second cycle of data collection comprises: (a) step 1004 in which involuntary data about food consumption is received from sound sensors that are worn in or on the person and the cumulative data (from both motion and sound sensors) is used to estimate caloric intake; (b) step 1005 in which voluntary data about food consumption is received from “level 2” actions performed by the person and the cumulative data (from both “level 1” and “level 2” actions) is used to estimate caloric intake; and (c) step 1006 in which these two estimates are compared to determined whether they meet the criteria for similarity and/or convergence. If these criteria are met, then the method stops.

If the criteria for similarity and/or convergence are not met in step 1006, then this method escalates to a third cycle of more-intrusive collection of additional involuntary and voluntary data about food consumption. This third cycle is shown in the last row of steps in FIG. 10. This third cycle of data collection comprises: step 1007 in which involuntary data about food consumption is received from imaging sensors that are worn in or on the person and the cumulative data (from motion, sound, and imaging sensors) is used to estimate caloric intake; and step 1008 in which voluntary data about food consumption is received from “level 3” actions performed by the person and the cumulative data (from level 1, 2, and 3 actions) is used to estimate caloric intake.

FIG. 10 shows an example of a method for measuring caloric intake in which the intrusiveness of data collection is escalated only as far as is required to achieve a desired level of accuracy. In this respect, this method could be called “minimally-intrusive” yet highly-accurate caloric intake monitoring. This method can achieve accuracy that is superior to methods of estimating caloric intake in the prior art that rely on voluntary data collection only—especially voluntary methods with no empirically-validated methods to encourage compliance and accuracy. This method can be better (greater accuracy and/or greater privacy) than methods of estimating caloric intake in the prior art that rely on involuntary data collection through a static configuration of sensors, especially a static configuration of more-intrusive sensors. FIG. 10 illustrates how this method achieves the optimal tradeoff between accuracy and intrusiveness in caloric intake measurement. This is superior to methods and systems for caloric intake measurement in the prior art.

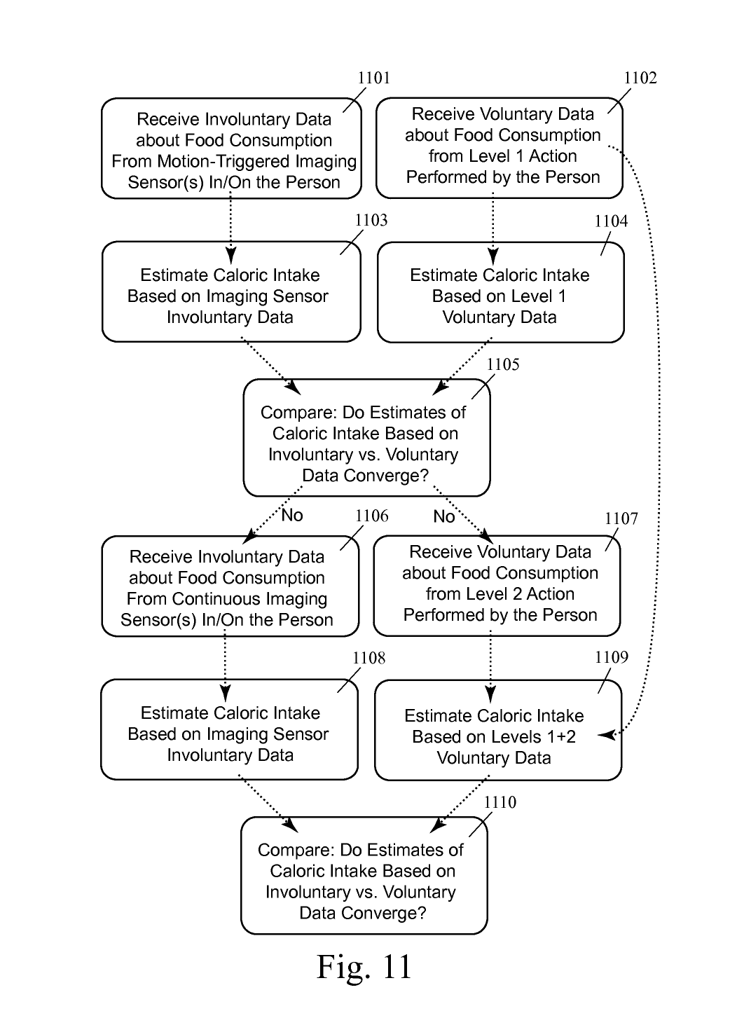

FIG. 11 shows another example of how this invention can be embodied in a method and system for measuring a person's caloric intake. The method shown in FIG. 11 is similar to the methods with two cycles of data collection that were shown in FIGS. 7 through 9, except that now escalation in the intrusiveness of involuntary data collection (in successive cycles) is done through an increase in the continuity of sensor operation rather than a change in sensor type (or modality). In FIG. 11, the same type of sensor is used for both the first and second cycles of involuntary data collection, but the sensor operates in a less-continuous manner in the first (less-intrusive) data collection cycle and operates in a more-continuous manner in the second (more-intrusive) data collection cycle. If there is similarity and/or convergence between caloric intake estimates from involuntary and voluntary data in the first cycle, then the person is spared having the sensor operate in a continuous manner. In various examples, the sensor may be a motion sensor, a sound sensor, an imaging sensor, or a combination thereof. As with previous examples of this invention, with the method shown in FIG. 11 the person has incentives to provide timely and accurate voluntary data concerning food consumption in the first cycle of data collection. If the person provides timely and accurate voluntary data in the first cycle, then the person is spared having one or more sensors record information in a more continuous manner. In this way, this method actively engages the person in managing their own energy balance and weight. Such active engagement of the person is not provided by methods in the prior art in which involuntary sensors are always in continuous operation, regardless of the person's behavior or compliance. Such active engagement of the person in managing their own energy balance is important not only as a technical method for improving measurement accuracy, but also for encouraging weight management in a holistic manner.

The method and system for caloric intake measurement that is shown in FIG. 11 begins with a first cycle of data collection that comprises the five steps that are shown in the upper half of FIG. 11. The first cycle in FIG. 11 includes step 1101 in which involuntary data about food consumption is received from one or more sensors that are worn in or on the person, wherein these sensors operate in a non-continuous manner. In an example, one or more wearable sensors may sample data periodically. In an example, one or more of sensors may sample data at random intervals.

In an example, a sensor of a generally more-intrusive type (that operates in a less-continuous manner) can collect data only when it is triggered by the results from a sensor of a generally less-intrusive type (that operates in more-continuous manner). For example, a generally more-intrusive imaging sensor may be activated to take pictures only when results from a generally less-intrusive motion sensor indicate that a person is probably eating. This is the case that is specified in FIG. 11. As shown in step 1101 in FIG. 11, involuntary data about food consumption is received from one or more motion-triggered imaging sensors that are worn on the person. In an example, these one or more imaging sensors may be wearable video cameras.

In an example, a motion-triggered imaging sensor may take video images for a set interval of time after analysis of output from the continually-operating motion sensor suggests that the person is eating. In another example, a motion-triggered imaging sensor may start taking pictures based on output from a motion sensor and may continue operation for as long as eating continues, wherein eating is determined based on the results of the motion sensor, the imaging sensor, or both. If analysis of images from the imaging sensor shows that the indication of probable eating by the motion sensor was a false alarm, then the imaging sensor can stop taking pictures. In an example, if the imaging sensor determines that a food source within view or reach of the person remains unfinished, then the imaging sensor may continue to take pictures even if motion stops for a period of time.

In another example, the duration of imaging by the imaging sensor can depend on the strength of the probability indication that eating is occurring. If the results from one or more sensors indicate, with a high level of certainty, that eating is occurring, then the imaging sensor may operate for a longer period of time. If the results from one or more sensors are less certain with respect to whether the person is eating, then the imaging sensor may operate for a shorter period of time.

In an example, the field of vision and the focal length of the wearable imaging sensor (such as a wearable digital video camera) can be adjusted automatically to track a particular object as the object moves, the sensor moves, or both the object and the sensor move. In an example, a wrist-worn camera may track the ends of the person's fingers wherein a utensil or glass is engaged. In an example, a wrist-worn camera may track the person's face and mouth even when the person is moves their arm and hand. In an example, a camera may continuously or periodically scan the space around the person's hand and/or mouth to increase the probability of automatically detecting food consumption. In an example, the field of vision and/or focal length of an imaging sensor may be automatically adjusted based on the output of a motion sensor. In an example, an imaging sensor and a motion sensor may both be incorporated into a device that is worn on the person's wrist. In an example, an imaging sensor may be worn on the person's neck and a sound sensor may be worn on the person's wrist.

The first cycle of data collection in FIG. 11 also includes step 1102 in which voluntary data about the person's food consumption is received from “level 1” action performed by the person. In an example, a “level 1” action can comprise having the person make a voice entry into a device, wherein this voice entry briefly describes food that will be, is being, or has been consumed. In another example, a “level 1” action can comprise having the person enter data about food consumption via a menu-driven, touch-screen-activated user interface. In another example, a “level 1” action can comprise having the person scan a bar code (or other identifying code) on the packaging of food that will be, is being, or has been consumed. In another example, a “level 1” action can comprise pattern recognition of a logo, other design, or wording on the food packaging.

As the first cycle in FIG. 11 continues, it moves to: step 1103 in which caloric intake is estimated based on involuntary data collected from the motion-triggered imaging sensor; and to step 1104 in which caloric intake is estimated based on voluntary data from the “level 1” action. This first cycle concludes with step 1105 in which these two estimates of caloric intake are compared to each other in order to determine whether they meet the criteria for similarity and/or convergence. If these two estimates do meet the criteria for similarity and/or convergence, then this method stops after the first cycle of data collection. If these two estimates do not meet the criteria for similarity and/or convergence, then this method continues to a second cycle of data collection as shown in the bottom half of FIG. 11.

In the method shown in FIG. 11, if the two estimates from the first cycle of data collection do not meet the criteria for similarity and/or convergence in step 1105, then this method escalates to a second cycle of more-intrusive data collection. This second cycle begins with step 1106 in which involuntary data about a person's food consumption is received from an imaging sensor that is worn on the person and takes pictures in a more continuous manner than in the first cycle. In an example, this imaging sensor can be a miniature video camera that is worn by the person and which continuously takes video images of the space surrounding the person in this second cycle of more-intrusive data collection.

Continuous video imaging of the space surrounding a person, especially space near the person's mouth and hands, is likely to provide relatively accurate monitoring of food consumption. However, continuous video imaging of the space surrounding a person, including whatever or whoever enters that space, can be relatively intrusive. Some approaches in the prior art that rely on continuous video imaging seek to address privacy concerns by having automated screening mechanisms that screen out images of people or things that would infringe on privacy. The embodiments of this invention that are described herein can also include automated screening mechanisms to enhance privacy. However, this invention can potentially avoid this problem entirely and avoid continuous video in the first place, by encouraging the person to enter timely and accurate voluntary data about food consumption in the first cycle.

Methods and systems in the prior art in which a wearable camera takes video images continuously regardless of the person's compliance or behavior can be unnecessarily intrusive. Granted, such systems may be modified to screen out privacy-invading sounds and images, but why create these sounds and images in the first place if they are redundant and unnecessary? Why subject a person to continuous video monitoring if the person is willing to provide consistently timely and accurate voluntary data concerning food consumption? Why not give them a choice? This present invention, as shown various embodiments including that shown in FIG. 11, gives a person this choice. This present invention does not escalate to continuous imaging if the combination of eating-motion-triggered imaging and voluntary data reporting is sufficient to achieve the desired level of accuracy in caloric intake measurement in the first cycle of data collection.

In an example, the “level 2” action in step 1107 of FIG. 11 can comprise having the person manually focus and trigger (“point and shoot”) a camera toward food that will be consumed. In another example, “level 2” action can comprise having the person respond to a series of menu-driven prompts on a mobile touch screen device in order to precisely identify food that will be, is being, or has been consumed. In another example, “level 2” action can comprise having the person answer an automatically-generated phone call and give a series of response to voice-prompts in order to precisely identify consumed food.

In addition to technical advantages over the prior art, this present invention also has psychological and motivational advantages over prior art that relies on continuous imaging regardless of the person's behavior. This present invention engages the person in managing their own energy balance and weight in a constructive manner that is not provided by methods in the prior art that always use continuous video imaging. With this present invention, the person is an actively-engaged participant in the measurement and management of their energy balance and body weight. The degree to which they are continually monitored depends on their behavior. In some respects, the system allows the person to earn “trust” (and greater monitoring freedom) by demonstrating past compliance with accurate dietary monitoring. This is an improvement over prior art in which a person is in a passive role (like a subject in an experiment) and is continuously monitored regardless of how well they behave.

The example of this invention that is shown in FIG. 12 is similar to the method that was shown in FIG. 11, except that now the non-continuous imaging sensor in step 1201 is activated by the output of wearable sound sensor instead of a wearable motion sensor. In an example, a sound sensor may be worn on the person's neck in a manner like a necklace. In an example, a sound sensor may be worn behind the person's ear in a manner like a bluetooth communication device. In an example, when the sound sensor detects chewing, biting, or swallowing sounds, the sound sensor can activate an imaging sensor which can better determine what, if anything, the person is eating. Apart from substituting a sound sensor for a motion sensor, the other steps in FIG. 12 have the same descriptions as those in FIG. 11 which are labeled with the same last 2 digits.

As shown in FIGS. 5 through 12, this invention can be embodied in a method for measuring a person's caloric intake comprising: (a) receiving a first set of data concerning what the person eats from a first source and receiving a second set of data concerning what the person eats from a second source; (b) calculating a first estimate of the person's caloric intake based on the first set of data, calculating a second estimate of the person's caloric intake based on the second set of data, and comparing these first and second estimates of caloric intake to determine whether these estimates meet criteria for similarity and/or convergence; and (c) if the first and second estimates of caloric intake do not meet the criteria for similarity and/or convergence, then receiving a third set of data concerning what the person eats and calculating one or more new estimates of caloric intake using this third set of data.

In an example, collection of the first set of data does not require voluntary actions by the person associated with particular eating events other than the actions of eating, but collection of the second set of data requires voluntary actions by the person associated with particular eating events other than the actions of eating, or vice versa. In an example, receiving the first set of data does not require voluntary actions by the person associated with particular eating events other than the actions of eating, but receiving the second set of data requires voluntary actions by the person associated with particular eating events other than the actions of eating, or vice versa.

In an example, data collection methods or methods of receiving data can be selected from the group consisting of: (a) collection of the first and third sets of data does not require voluntary actions by the person associated with particular eating events other than the actions of eating, but collection of the second set of data does require voluntary actions by the person associated with particular eating events other than the actions of eating; (b) collection of the first and second sets of data does not require voluntary actions by the person associated with particular eating events other than the actions of eating, but collection of the third set of data does require voluntary actions by the person associated with particular eating events other than the actions of eating; and (c) collection of the first set of data does not require voluntary actions by the person associated with particular eating events other than the actions of eating, but collection of the second and third sets of data does require voluntary actions by the person associated with particular eating events other than the actions of eating.

In an example, data collection methods or methods of receiving data can be selected from the group consisting of: (a) receiving the first and third sets of data does not require voluntary actions by the person associated with particular eating events other than the actions of eating, but receiving the second set of data does require voluntary actions by the person associated with particular eating events other than the actions of eating; (b) receiving the first and second sets of data does not require voluntary actions by the person associated with particular eating events other than the actions of eating, but receiving the third set of data does require voluntary actions by the person associated with particular eating events other than the actions of eating; and (c) receiving the first set of data does not require voluntary actions by the person associated with particular eating events other than the actions of eating, but receiving the second and third sets of data does require voluntary actions by the person associated with particular eating events other than the actions of eating.

In an example, this invention can be embodied in a method for measuring a person's caloric intake comprising: (a) receiving a first set of data concerning what the person eats in a manner that does not require voluntary actions by the person associated with particular eating events other than the actions of eating; (b) receiving a second set of data concerning what the person eats in a manner that requires voluntary actions by the person associated with particular eating events other than the actions of eating; (c) calculating a first estimate of the person's caloric intake based on the first set of data, calculating a second estimate of the person's caloric intake based on the second set of data, and comparing these first and second estimates of caloric intake to determine whether these estimates meet criteria for similarity and/or convergence; and (d) if the first and second estimates of caloric intake do not meet the criteria for similarity and/or convergence, then receiving a third set of data concerning what the person eats and calculating one or more new estimates of caloric intake using this third set of data.

As shown in FIGS. 5 through 12, data sets can be selected from the group consisting of: (a) at least one of the first set of data and the second set of data comprises image data whose collection requires voluntary actions by the person associated with particular eating events other than the actions of eating and the third set of data comprises image data whose collection is more continuous than the collection of at least one of the first and second sets of data; (b) at least one of the first set of data and the second set of data comprises image data whose collection is intermittent, periodic, or random, not requiring voluntary actions by the person associated with particular eating events other than the actions of eating, and the third set of data comprises image data whose collection is more continuous than the collection of at least one of the first and second sets of data; and (c) at least one of the first set of data and the second set of data comprises image data whose collection is triggered by sounds, motions, or sounds and motions indicating an eating event, wherein this collection does not require voluntary actions by the person associated with particular eating events other than the actions of eating, and the third set of data comprises image data whose collection is more continuous than the collection of at least one of the first and second sets of data.

In an example, at least one of the first set of data and the second set of data comprises sound data, motion data, or both sound and motion data, the third set of data comprises image data, and collection of these sets of data does not require voluntary actions by the person associated with particular eating events other than the actions of eating. In an example, the criteria for similarity and/or convergence are selected from the group consisting of: raw difference between two values is less than a target value; percentage difference between two values is less than a target value; mathematical analysis of paired variables predicts convergence between them; and statistical analysis of two variables does not show a statistically-significant difference between them.

As shown in FIGS. 5 through 12, this invention can be embodied in a method for measuring a person's caloric intake comprising: (a) receiving a first set of data from a first source concerning what the person eats, wherein collecting this first set of data requires a first level of intrusion into the person's privacy or time, and receiving a second set of data from a second source concerning what the person eats, wherein collecting this second set of data requires a second level of intrusion into the person's privacy or time; (b) calculating a first estimate of the person's caloric intake based on the first set of data, calculating a second estimate of the person's caloric intake based on the second set of data, and comparing these first and second estimates of caloric intake to determine whether these estimates meet criteria for similarity and/or convergence; and (c) if the first and second estimates of caloric intake do not meet the criteria for similarity and/or convergence, then receiving a third set of data concerning what the person eats, wherein collection of this third set of data requires a third level of intrusion into the person's privacy or time, and wherein this third level is greater than the first level and is greater than the second level, and calculating a third estimate of caloric intake based, in whole or in part, on this third set of data.

In an example, this invention can be embodied in a method for measuring the types and quantities of food consumed by a person comprising: (a) receiving a first set of data from a first source concerning what the person eats and receiving a second set of data from a second source concerning what the person eats; (b) calculating a first estimate of the types and quantities of food consumed based on the first set of data, calculating a second estimate of the types and quantities of food consumed based on the second set of data, and comparing these first and second estimates of caloric intake to determine whether these estimates meet criteria for similarity and/or convergence; and then (c) if the first and second estimates of caloric intake do not meet the criteria for similarity and/or convergence, then receiving a third set of data concerning what the person eats and calculating a third estimate of the types and quantities of food consumed using this third set of data.

In an example, collection of the first set of data does not require voluntary actions by the person associated with particular eating events other than the actions of eating, but collection of the second set of data does require voluntary actions by the person associated with particular eating events other than the actions of eating, or vice versa. In an example, receiving the first set of data does not require voluntary actions by the person associated with particular eating events other than the actions of eating, but receiving the second set of data does require voluntary actions by the person associated with particular eating events other than the actions of eating, or vice versa.

In an example, collection of the first and third sets of data does not require voluntary actions by the person associated with particular eating events other than the actions of eating, but collection of the second set of data does require voluntary actions by the person associated with particular eating events other than the actions of eating. In an example, collection of the first and second sets of data does not require voluntary actions by the person associated with particular eating events other than the actions of eating, but collection of the third set of data does require voluntary actions by the person associated with particular eating events other than the actions of eating. In an example, collection of the first set of data does not require voluntary actions by the person associated with particular eating events other than the actions of eating, but collection of the second and third sets of data does require voluntary actions by the person associated with particular eating events other than the actions of eating. In an example, at least one of the first set of data and the second set of data comprises image data whose collection requires voluntary actions by the person associated with particular eating events other than the actions of eating, and the third set of data comprises image data whose collection is more continuous than the collection of at least one of the first and second sets of data.

In an example, at least one of the first set of data and the second set of data comprises image data whose collection is intermittent, periodic, or random, not requiring voluntary actions by the person associated with particular eating events other than the actions of eating, and the third set of data comprises image data whose collection is more continuous than the collection of at least one of the first and second sets of data. In an example, at least one of the first set of data and the second set of data comprises image data whose collection is triggered by sounds, motions, or sounds and motions indicating an eating event, not requiring voluntary actions by the person associated with particular eating events other than the actions of eating, and the third set of data comprises image data whose collection is more continuous than the collection of at least one of the first and second sets of data. In an example, at least one of the first set of data and the second set of data comprises sound data, motion data, or both sound and motion data, the third set of data comprises image data, and collection of these sets of data does not require voluntary actions by the person associated with particular eating events other than the actions of eating.

In an example, the criteria for similarity and/or convergence are selected from the group consisting of: raw difference between two values is not greater than a target value; percentage difference between two values is not greater than a target value; mathematical analysis of paired variables predicts convergence between them; and statistical analysis of two variables does not show a statistically-significant difference between them.

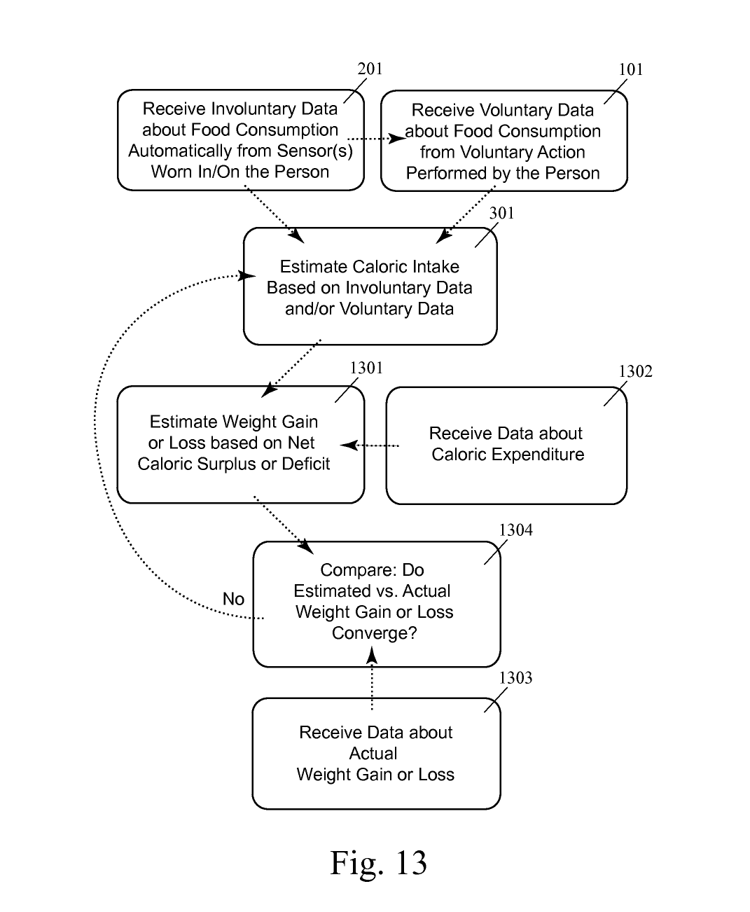

The embodiments of this invention that have been shown in FIGS. 5 through 12 all implicitly assume that the similarity and/or convergence of caloric estimates based on involuntary data and voluntary data can function as a proxy for accuracy. This is better than having no empirical basis at all for measuring the accuracy of data collected. However, we now relax this assumption for the examples of this invention which follow, starting with the example shown in FIG. 13. When it is possible to collect data about caloric expenditure and actual weight (gain or loss), in addition to data about caloric intake, then we no longer need to assume that the similarity of caloric intake estimates from two sources implies accuracy. We can test the accuracy of caloric intake measurement more directly by comparing predicted weight gain or loss to actual weight gain or loss.

In the examples of this invention that follow, beginning with the example shown in FIG. 13, the estimate of caloric expenditure for a period of time is subtracted from the estimate of caloric intake for a period of time in order to predict the person's weight gain or loss during that period of time. Then, the predicted weight gain or loss is compared to the actual weight gain or loss in order to test the accuracy of the estimate of caloric intake. If the predicted weight gain or loss is sufficiently close to the actual weight gain or loss, then this indicates that the estimated caloric intake is relatively accurate and no additional information or methodological adjustments are required.

However, if the predicted weight gain or loss is significantly different than the actual weight gain or loss, then this suggests that the estimate of caloric intake is not sufficiently accurate and that additional information or methodological adjustments are required. To be precise, such a difference could also be caused by imprecision in the estimation of caloric expenditure, but even in the case of imprecise caloric expenditure, improvement in the accuracy of caloric intake estimation will (holding other factors constant) cause greater similarity and/or convergence between predicted and actual weight gain or loss.

A person's weight gain or loss can be predicted because: net energy balance is caloric intake minus caloric expenditure; and weight gain or loss follows directly from net energy balance. Predicted weight gain or loss can then be compared to actual weight gain or loss. If estimated caloric intake is inaccurate, then predicted weight gain or loss will be significantly different than actual weight gain or loss. If estimated caloric intake is accurate (and caloric expenditure is also accurate), then predicted weight gain or loss will be close to actual weight gain or loss. Based on this logic, the examples of this invention that start with FIG. 13 evaluate the accuracy of caloric intake estimation based on the similarity and/or convergence of predicted weight gain or loss vs. actual weight gain or loss.

The example method of this invention that is shown in FIG. 13 starts in step 201 by receiving involuntary data about food consumption from one or more sensors that are worn in, or on, the person. These one or more sensors can be selected from the group consisting of: accelerometer, inclinometer, other motion sensor, sound sensor, smell or other olfactory sensor, blood pressure sensor, heart rate sensor, EEG sensor, ECG sensor, EMG sensor, electrical sensor, chemical sensor, gastric activity sensor, GPS sensor, camera or other image-creating sensor or device, optical sensor, piezoelectric sensor, respiration sensor, strain gauge, electrogoniometer, chewing sensor, swallow sensor, temperature sensor, and pressure sensor.

As also shown in FIG. 13, in step 101 voluntary data about food consumption is received from voluntary actions that are performed by the person in association with eating events, other than the actions of eating itself. In an example, step 101 may be prompted by the results of step 201. In another example, voluntary initiation of step 101 by the person may be independent of step 201.

In various examples, the voluntary data about food consumption that is collected in step 101 may be obtained from one or more actions selected from the group consisting of: having the person enter the types and portions of food consumed on paper or into an electronic device, having the person manually calculate or estimate calories consumed and record or enter them on paper or into an electronic device. In various examples, human-computer interface options may be selected from the group consisting of: touch screen, keypad, mouse and/or other cursor-moving device, speech or voice recognition, gesture recognition, scanning a bar code or other food code, and taking a picture of food or food packaging.

After involuntary data and voluntary data concerning food consumption are received in steps 201 and 101, this method then progresses to estimation of the person's caloric intake in step 301. In the method shown in FIG. 13, a single estimate of caloric intake is created. In an example, this single estimate may be created by combining, weighting, and/or merging involuntary data and voluntary data concerning food consumption. This is different than in the prior methods shown in FIGS. 5 through 12 wherein two different estimates of caloric intake were created, one estimate based on involuntary data and one estimate based on voluntary data. The reason for this difference is that the similarity and/or convergence of caloric intake estimates from involuntary and voluntary data is no longer needed in FIG. 13 as a proxy for accuracy. Thus, two separate estimates of caloric intake are not needed. Instead, in FIG. 13 and the methods that follow, the accuracy of caloric intake estimation is tested by the similarity and/or convergence of predicted vs. actual weight gain or loss.

In an example, caloric intake may be estimated by combining involuntary data and voluntary data concerning food consumption: using weights from a multivariate linear estimation model; using weights from a Bayesian statistical model; using linear or non-linear mathematical programming; or using other multivariate statistical methods. In an example, these weights may be standardized, based on empirical evidence from many people over multiple time periods. In an example, these weights may be customized to a particular individual, based on the individual's unique history of eating habits, sensor monitoring, and diet logging.

In an example, the key variables of this model (caloric intake, caloric expenditure, predicted weight gain or loss, and actual weight gain or loss) may be estimated for fixed duration, non-overlapping periods of time—such as individual days, weeks, months, or years. In an example, these key variables may be estimated for a rolling time period, such as a rolling 7-day period wherein, each day, one day is dropped from the beginning of the rolling time period and one day is added to the end of the rolling time period. In an example, the key variables of this model may be estimated for variable-length periods whose variable lengths are defined empirically by clustering together multiple eating and/or physical activity events.

In this example, data about the person's caloric expenditure is received in step 1302. For example, caloric expenditure can be estimated by one or more wearable motion sensors. There are many methods for estimating caloric expenditure in the prior art and the precise method for measuring caloric expenditure is not central to this invention. Accordingly, the precise method used for measuring caloric expenditure is not specified herein. Even if the method for measuring caloric expenditure is not completely accurate, the accuracy of estimated caloric intake will still be positively correlated with the accuracy of predicted weight gain or loss. Accordingly, this method can be used to evaluate the relative accuracy of estimated caloric intake even if there is error in the estimation of caloric expenditure. In an example, the criteria for similarity and/or convergence can be adjusted to reflect imprecision in the estimation of caloric expenditure.

Data about the person's actual weight gain or loss is received in step 1303. In an example, the person's actual weight (gain or loss) can be measured by having the person stand on a scale and having the scale wirelessly transmit the person's current weight to the same computing unit that performs caloric intake estimation. This computing unit can compare the person's current weight to the person's previous weight in order to calculate actual weight gain or loss. In an example, the person can manually enter current weight information from the scale via a human-computer interface such as touch screen, voice recognition, or keypad. In an example, the person may be prompted to stand on the scale periodically (e.g. each day, week, or month).

In a different example, the person's actual weight (gain or loss) may be monitored and estimated in an involuntary manner. For example, a camera may be placed in a location from which it can take pictures of the person in an automatic manner on a regular basis. In an example, these pictures may be automatically analyzed by three-dimensional image analysis in order to estimate the person's weight (gain or loss). In an example, pressure or weight sensors may be placed in locations where the person walks, sits, or reclines on a regular basis. Data from these pressure or weight sensors may be analyzed to estimate the person's weight (gain or loss).

In an example, data concerning the person's current weight on a scale may be adjusted to reflect differences in what the person is wearing, the time of day, the proximity to an eating event, or other factors which may temporarily distort the person's weight. In an example, information concerning these factors may be voluntarily recorded by the person or automatically identified by one or more sensors. In an example, a camera in association with a scale may recognize the types of clothing currently worn by the person and adjust estimation of the person's current weight accordingly.

In the method and system for measuring a person's caloric intake that is shown in FIG. 13, the person's predicted weight gain or loss for a period of time is calculated in step 1301. The person's predicted weight gain or loss is calculated based on the estimate of caloric intake from step 301 and the estimate of caloric expenditure from step 1302. Then, in step 1304, the person's predicted weight gain or loss is compared to the person's actual weight gain or loss.

If the values for predicted vs. actual weight gain or loss meet the criteria for similarity and/or convergence in step 1304, then the method concludes with this step. However, if the values for predicted vs. actual weight gain or loss do not meet the criteria for similarity and/or convergence in step 1304, then this method cycles back to step 301 and the process for estimating caloric intake from involuntary data and voluntary data is adjusted. This cycling back to step 301 is represented in FIG. 13 by a dotted-line arrow (labeled “No” for “no convergence”) that goes upwards from step 1304 to step 301. In an example, this iterative cycle of estimation adjustment can repeat indefinitely until the criteria for similarity and/or convergence are met. In an example, this cycle may only repeat until the earlier of: criteria for similarity and/or convergence are met; or a target maximum number of cycles occur. The criteria for similarity and/or convergence can be selected from those that were specified in this disclosure for earlier figures.

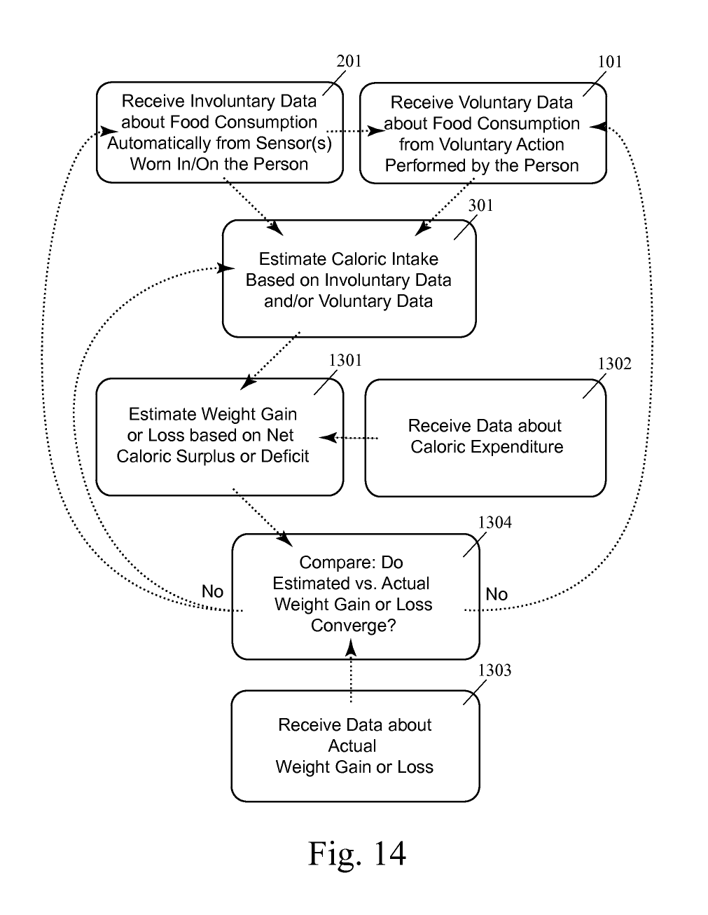

The method for measuring caloric intake that is shown in FIG. 13 relies only on adjustment of the process (or model) for estimating caloric intake in step 301 in order to improve the estimate of caloric intake to achieve similarity and/or convergence of the predicted vs. actual weight gain or loss. However, the method shown in FIG. 14 now expands the adjustment process to also include potential collection of additional involuntary data and/or voluntary data to refine caloric intake estimation. The method in FIG. 14 comprises the same steps as those in FIG. 13, but now also includes dotted-line arrows from step 1304 back to steps 201 and 101. These dotted-line arrows indicate that, in this method, additional involuntary data and voluntary data concerning food consumption can be collected if the criteria for similarity and/or convergence of predicted vs. actual weight gain or loss are not met in step 1304.

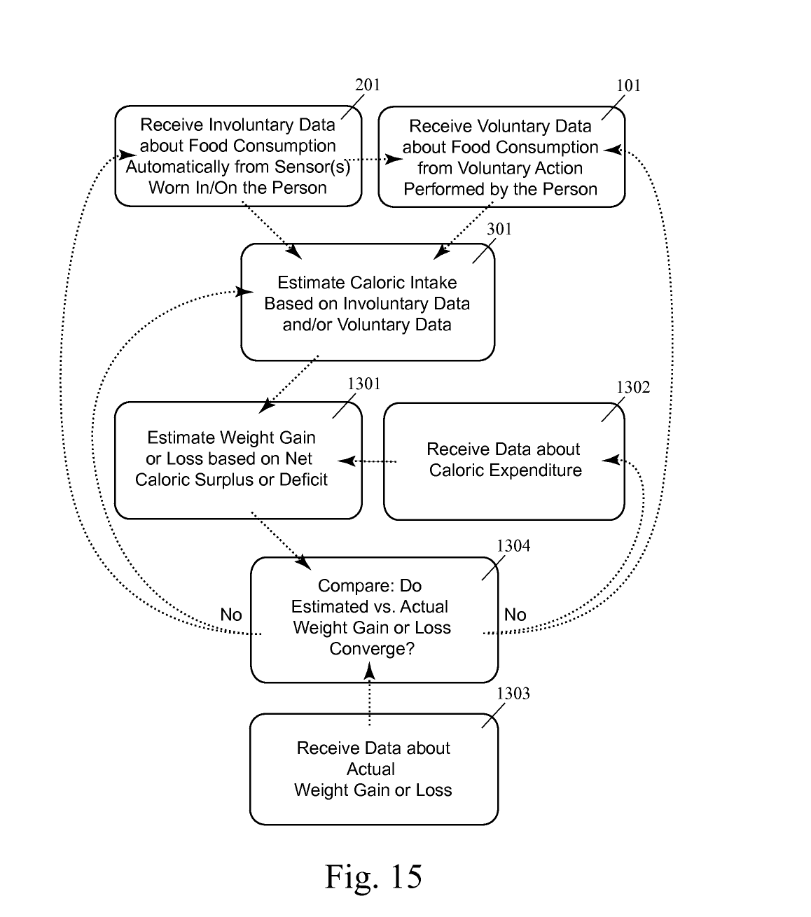

The method shown in FIG. 15 further expands the breadth of adjustment by also adding possible collection of additional information concerning caloric expenditure when convergence and/or similarity criteria are not met.

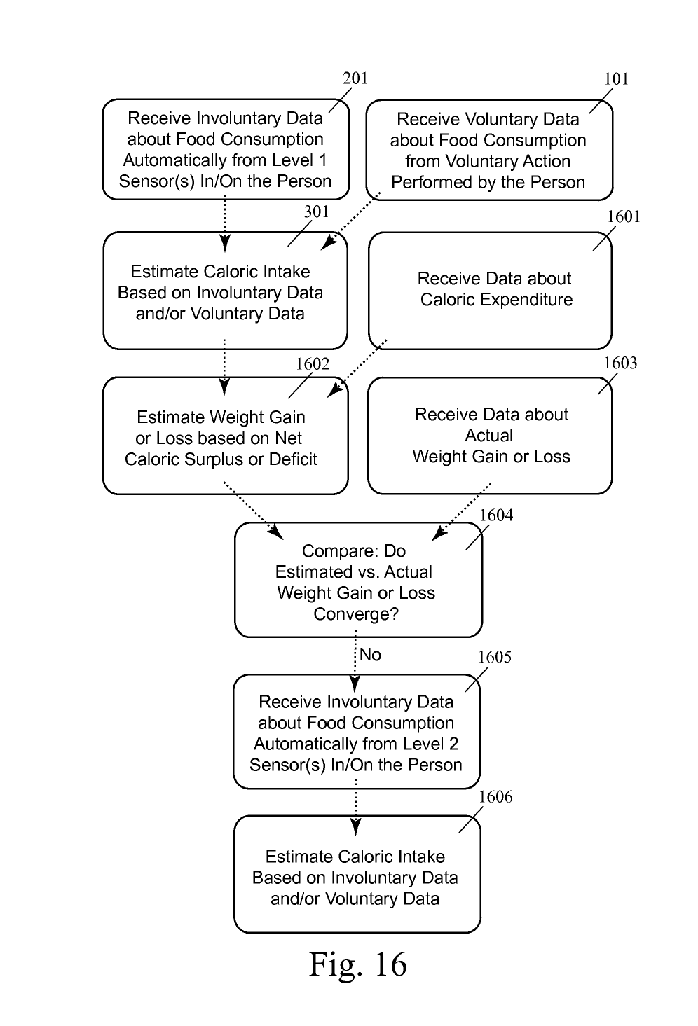

The examples of this invention that are subsequently shown in FIGS. 16 through 20 may be seen as variations on the example that is shown in FIG. 15, with three main differences. These three main differences are: (1) FIGS. 16 through 20 show a maximum of two cycles of data collection and/or estimation process adjustment; (2) FIGS. 16 through 20 show additional involuntary data collection only in the second cycle of data collection; and (3) FIGS. 16 through 20 provide greater specificity with respect to the types, activation, and timing of the sensors that are used to collect involuntary data about food consumption.

FIG. 16 shows one example of how this invention may be embodied in a method for measuring caloric intake which escalates from collecting data on food consumption from “level 1” (less intrusive) automatic sensors to collecting data on food consumption from “level 2” (more intrusive) automatic sensors—if the “level 1” sensors do not achieve a desired level of measurement accuracy. In an example, “level 1” sensors can be less-intrusive because of their low-level modality (e.g. motion or sound), non-continuous operation (e.g. only when triggered by an eating event), low-profile placement (e.g. under clothing), and/or flexible timing (e.g. delayed data acquisition at the end of the day). In an example, “level 2” can be more-intrusive because of their high-level modality (e.g. images), continuous operation, high-profile placement (e.g. around the neck), and/or immediate timing (e.g. real time data acquisition while eating).

The method in FIG. 16 starts, in step 201, with the collection of involuntary data concerning food consumption from “level 1” sensors that are worn in, or on, the person. In step 101, voluntary data is collected concerning food consumption. Also, in step 301, the person's caloric intake is estimated based on a combination, weighting, or merging of involuntary data from step 201 and voluntary data from step 101. In step 1601, data is collected and received concerning the person's caloric expenditure. In step 1602, predicted weight gain or loss for the person is estimated based on the person's caloric intake minus the person's caloric expenditure (i.e. net energy balance).

In step 1603, data concerning the person's actual weight (gain or loss) is received. Then, in step 1604, predicted weight gain or loss for the person is compared to actual weight gain or loss for the person. If predicted vs. actual weight gain or loss meet the criteria for similarity and/or convergence, then the method stops. If predicted vs. actual weight gain or loss do not meet the criteria for similarity and/or convergence, then the method escalates to step 1605 in which involuntary data concerning food consumption is collected from “level 2” sensors. Finally, a new estimate of caloric intake is calculated in step 1606 based on both “level 1” and “level 2” involuntary data (as well as the original voluntary data).

The method shown in FIG. 16 provides the person with incentives to provide accurate and timely voluntary data concerning food consumption. One such incentive is the avoidance of more-intrusive automatic data collection in step 1605. If the combination of “level 1” involuntary data and voluntary data combine to accurately predict caloric intake (as determined in step 1604), then the person can avoid being monitored by “level 2” sensors. In this manner, as the person becomes more engaged, timely, and accurate with respect to voluntary reporting of caloric intake, then involuntary data collection becomes less intrusive.

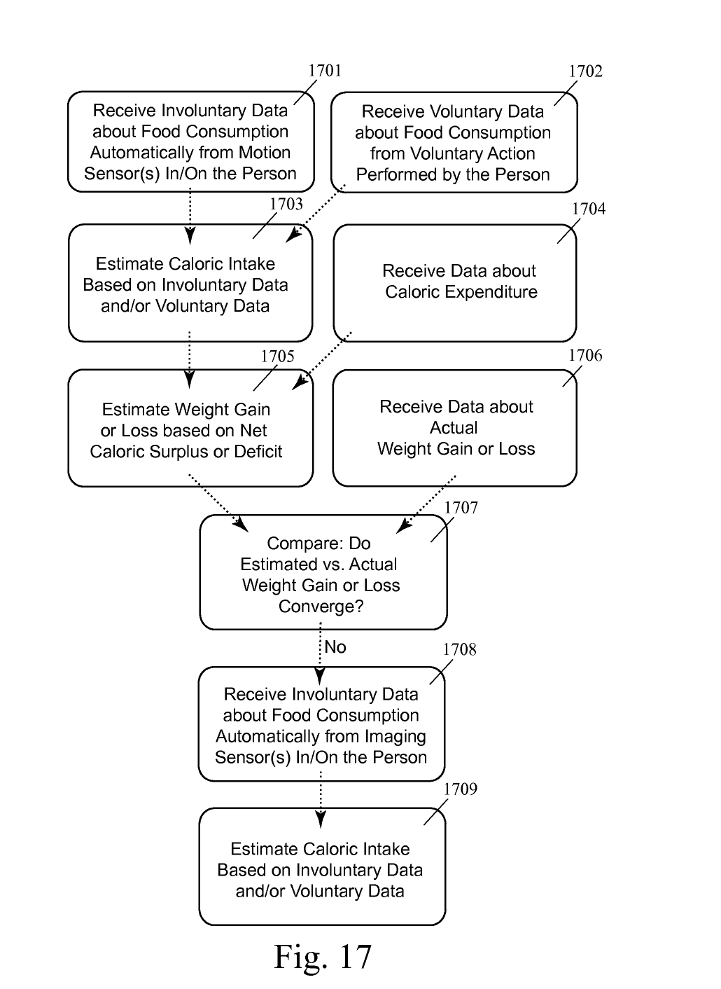

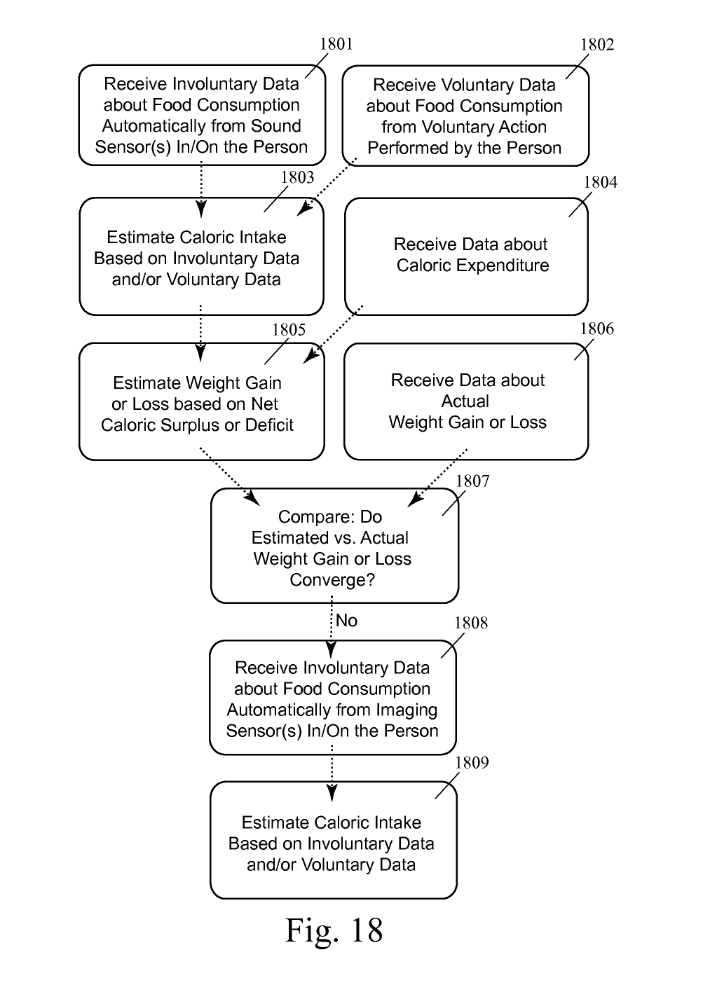

The method shown in FIG. 17 is similar to that shown in FIG. 16 except that the types of involuntary data sensors that are used in “level 1” vs. “level 2” are explicitly specified. As shown in step 1701 of FIG. 17, one or more wearable motion sensors (such as wearable accelerometers) are used to collect data concerning food consumption in “level 1”. As shown in step 1708 of FIG. 17, one or more wearable image sensors (such as wearable cameras) are used to collect data concerning food consumption in “level 2”. The example in FIG. 18 is like that in FIG. 17 except that one or more wearable sound sensors (such as wearable microphones) as used in “level 1” in step 1801. The other steps in FIGS. 17 and 18 are the same as the steps located in similar diagrammatic positions in FIG. 16.

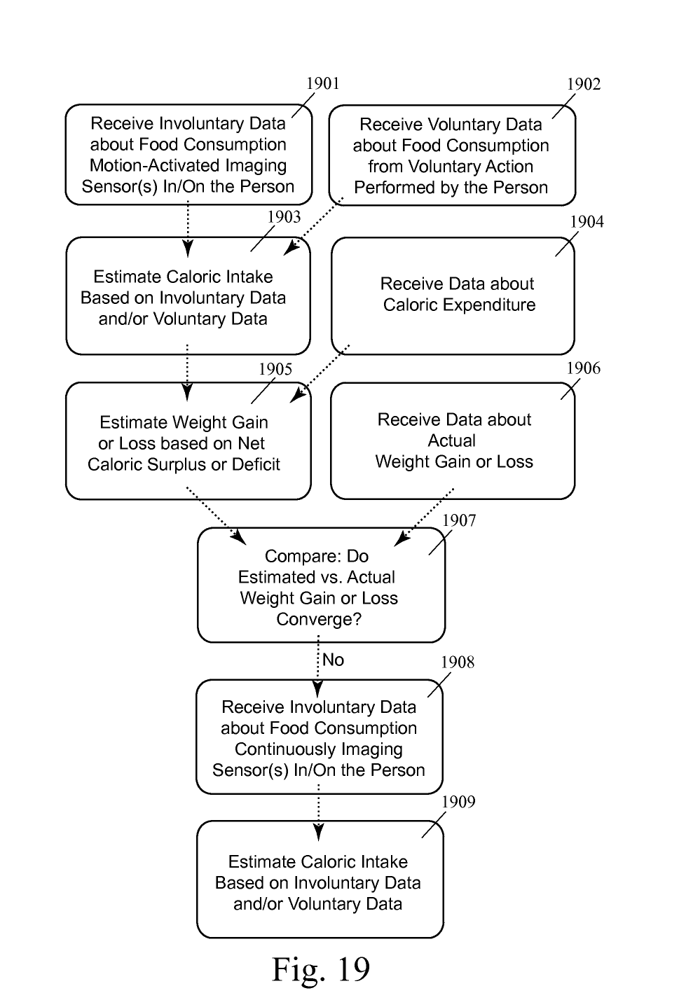

The method shown in FIG. 19 is similar to that shown in FIG. 16 except that “level 1” vs. “level 2” automatic sensors are differentiated by the timing of their operation, not their type or modality. As shown in step 1901, in the first round of involuntary data collection in FIG. 19, the automatic sensor is a motion-activated imaging sensor (such as a wearable camera) that only collects information on food consumption when the person's movements suggest that the person is eating. This is less intrusive on the person's privacy than an imaging sensor that takes pictures continuously.

As shown in step 1908, in the second round of involuntary data collection (if convergence is not achieved in step 1907), an automatic imaging sensor takes pictures continuously. In an example, this imaging sensor can be a wearable video camera. In an example, this imaging sensor can be worn on the person's wrist, neck, head, or torso. In an example, this imaging sensor can continuously track the location of the person's mouth and take continuous video images of the person's mouth to detect and identify food consumption. In an example, this imaging sensor can continuously track the location of the person's hands and take continuous video images of the space near the person's fingers to detect and identify food consumption.

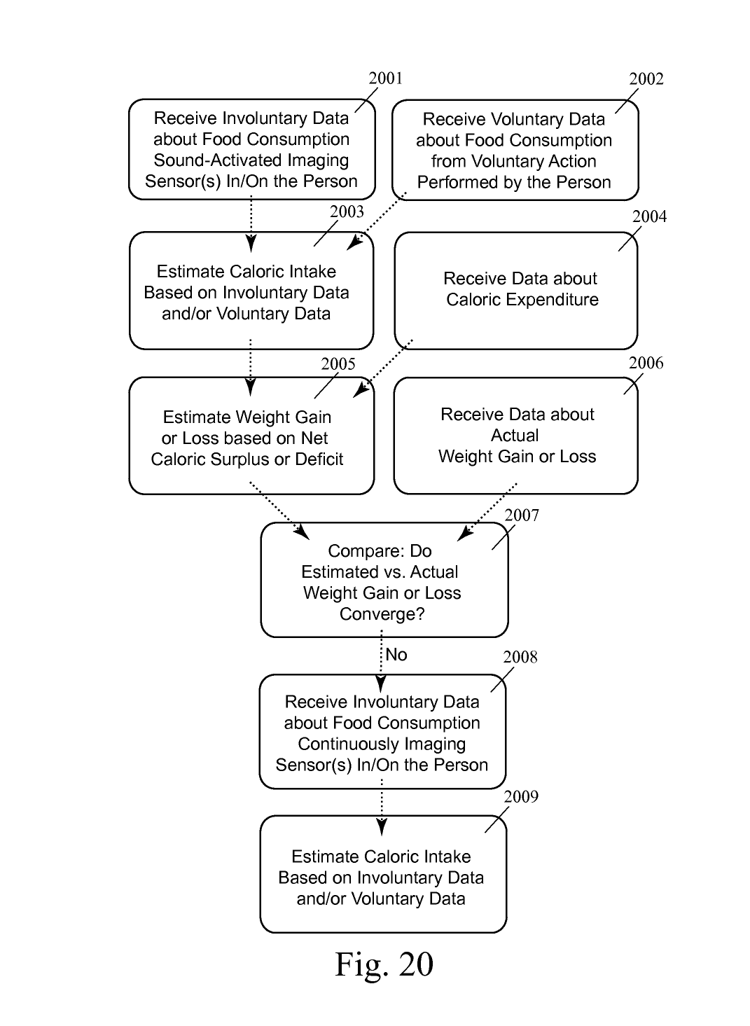

The method shown in FIG. 20 is like that shown in FIG. 19, except that the non-continuous imaging sensor in the first round of involuntary data collection is a sound-activated imaging sensor. In an example, the imaging sensor (such as a wearable video camera) can be activated to take pictures by chewing, biting, or swallowing sounds that are detected by a wearable microphone. The other steps in FIGS. 19 and 20 are the same as the steps located in similar diagrammatic positions in FIG. 16.

As shown in FIGS. 13 through 20, this invention can be embodied in a method for measuring a person's caloric intake comprising: (a) receiving a first set of data concerning what the person eats; (b) calculating a first estimate of the person's caloric intake based on the first set of data, using this first estimate of the person's caloric intake to estimate predicted weight change for the person during a period of time, and comparing predicted weight change to actual weight change to determine whether predicted weight change and actual weight change meet criteria for similarity and/or convergence; and (c) if predicted weight change and actual weight change do not meet the criteria for similarity and/or convergence, then receiving a second set of data concerning what the person eats and calculating a second estimate of caloric intake using this second set of data.

In an example, collecting the first set of data does not require voluntary actions by the person associated with particular eating events other than the actions of eating, but collecting the second set of data does require voluntary actions by the person associated with particular eating events other than the actions of eating. In an example, collecting the second set of data does not require voluntary actions by the person associated with particular eating events other than the actions of eating, but collecting the first set of data does require voluntary actions by the person associated with particular eating events other than the actions of eating.

As shown in FIGS. 13 through 20, a first set of data can be received concerning what the person eats, wherein this first set includes involuntary data that is collected in a manner that does not require voluntary actions by the person associated with particular eating events other than the actions of eating, and wherein this first set also includes voluntary data that is collected in a manner that requires voluntary actions by the person associated with particular eating events other than the actions of eating.

As shown in FIGS. 13 through 20, this invention can be embodied in a method for measuring a person's caloric intake comprising: (a) receiving a first set of data concerning what the person eats, wherein this first set includes involuntary data that is collected in a manner that does not require voluntary actions by the person associated with particular eating events other than the actions of eating, and wherein this first set also includes voluntary data that is collected in a manner that requires voluntary actions by the person associated with particular eating events other than the actions of eating and; (b) calculating a first estimate of the person's caloric intake based on this first set of data, using this first estimate of the person's caloric intake to estimate predicted weight change for the person during a period of time, and comparing predicted weight change to actual weight change to determine whether predicted weight change and actual weight change meet criteria for similarity and/or convergence; and (c) if predicted weight change and actual weight change do not meet the criteria for similarity and/or convergence, then receiving a second set of data concerning what the person eats and calculating a second estimate of caloric intake using this second set of data.

In an example, the first set of data comprises image data whose collection requires voluntary actions by the person associated with particular eating events other than the actions of eating and the second set of data comprises image data whose collection is more continuous than that of the first set of data. In an example, the first set of data comprises image data whose collection is intermittent, periodic, or random, not requiring voluntary actions by the person associated with particular eating events other than the actions of eating, and the second set of data comprises image data whose collection is more continuous than that of the first set of data. In an example, the first set of data comprises image data whose collection is triggered by sounds, motions, or sounds and motions indicating an eating event, not requiring voluntary actions by the person associated with particular eating events other than the actions of eating, and the second set of data comprises image data whose collection is more continuous than that of the first set of data. In an example, the first set of data comprises sound data, motion data, or both sound and motion data, and wherein the second set of data comprises image data.

As shown in FIGS. 13 through 20, this invention can be embodied in a method for measuring a person's caloric intake comprising: (a) receiving a first set of data concerning what the person eats, wherein collecting this first set of data requires a first level of intrusion into the person's privacy or time; (b) calculating a first estimate of the person's caloric intake based on the first set of data, using this first estimate of the person's caloric intake to estimate predicted weight change for the person during a period of time, and comparing predicted weight change to actual weight change to determine whether predicted weight change and actual weight change meet criteria for similarity and/or convergence; and (c) if predicted weight change and actual weight change do not meet the criteria for similarity and/or convergence, then receiving a second set of data concerning what the person eats, wherein collection of this second set of data requires a second level of intrusion into the person's privacy or time that is greater than the first level, and calculating a second estimate of caloric intake based, in whole or in part, on this second set of data.

In an example, this invention can be embodied in a method for measuring the types and quantities of food consumed by a person comprising: (a) receiving a first set of data concerning what the person eats; (b) calculating a first estimate of the types and quantities of food consumed based on the first set of data, using this first estimate of the types and quantities of food consumed to estimate predicted weight change for the person during a period of time, and comparing predicted to actual weight change to determine whether predicted and actual weight change meet criteria for similarity and/or convergence; and then (c) if predicted weight change and actual weight change do not meet the criteria for similarity and/or convergence, then receiving a second set of data concerning what the person eats and calculating a second estimate of the types and quantities of food consumed using this second set of data.

In an example, collection of the first set of data does not require voluntary actions by the person associated with particular eating events other than the actions of eating, but collection of the second set of data does require voluntary actions by the person associated with particular eating events other than the actions of eating. In an example, collection of the second set of data does not require voluntary actions by the person associated with particular eating events other than the actions of eating, but collection of the first set of data does require voluntary actions by the person associated with particular eating events other than the actions of eating.

In an example, the first set of data comprises image data whose collection requires voluntary actions by the person associated with particular eating events other than the actions of eating, and the second set of data comprises image data whose collection is more continuous than that of the first set of data. In an example, the first set of data comprises image data whose collection is intermittent, periodic, or random, not requiring voluntary actions by the person associated with particular eating events other than the actions of eating, and the second set of data comprises image data whose collection is more continuous than that of the first set of data. In an example, the first set of data comprises image data whose collection is triggered by sounds, motions, or sounds and motions indicating an eating event, not requiring voluntary actions by the person associated with particular eating events other than the actions of eating, and the second set of data comprises image data whose collection is more continuous than that of the first set of data. In an example, the first set of data comprises sound data, motion data, or both sound and motion data, the second set of data comprises image data, and neither the collection the first set of data nor the collection of the second set of data requires voluntary actions by the person associated with particular eating events other than the actions of eating.

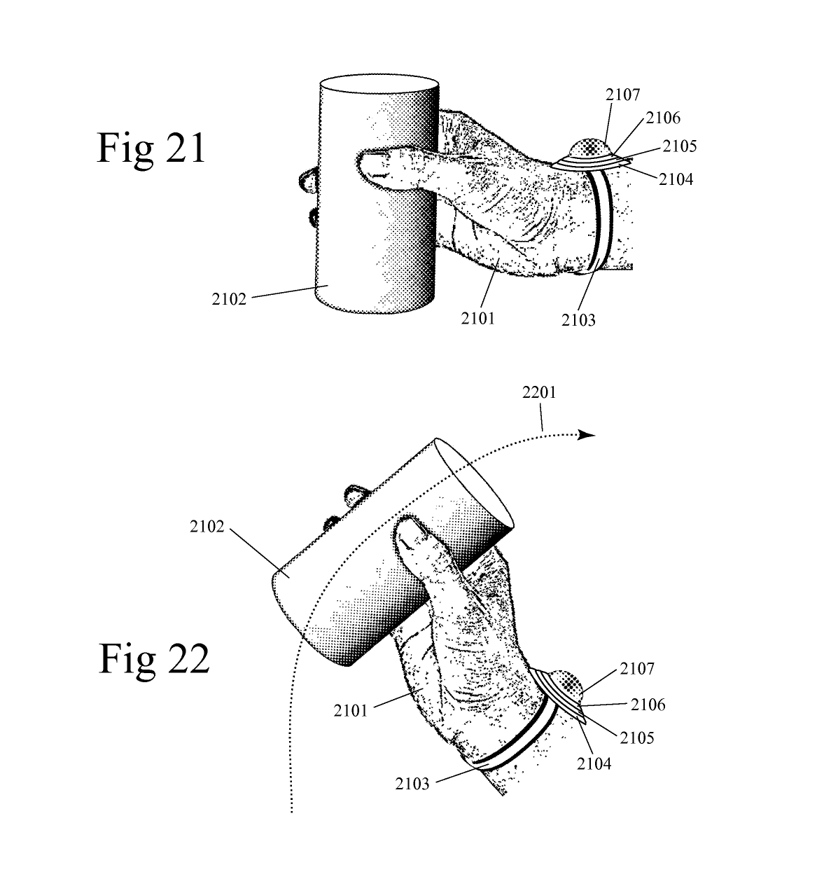

FIGS. 21 through 27 show a sequence of images that illustrate the structure and operational stages of an example of how this invention may be embodied in a wearable device that measures a person's caloric intake. In this example, the device is worn on a person's wrist in a manner similar to a wrist watch. This device includes: (a) a motion sensor that automatically analyzes movement of the person's wrist to detect when the person is probably eating; (b) a microphone and speaker unit, with voice recognition capability, which enables two-way vocal communication between the device and the person; (c) a wireless data processing and transmission unit that communicates with a remote scale; and (d) a miniature video camera that automatically takes pictures of food as it is transported to the person's mouth by the person's hand. We now discuss these figures in detail.

FIG. 21 shows a person's hand 2101 holding a food-transporting member 2102 that transports food up to the person's mouth. In this example, food is broadly defined to include liquid beverages, as well as solid and semi-solid food. In this example, the food-transporting member is a glass that contains a drinkable beverage. In various examples, the food-transporting member may be a cup, mug, or other beverage container. In an example, the food-transporting member may be a fork, spoon, chop stick, or other utensil that transports solid or semi-solid food up to the person's mouth. In an example, the person may transport food directly to their mouth by grasping it with their fingers, without the need for a food-transporting member as an intermediary. For example, the person may grasp a piece of food (such as a potato chip or a peanut or an apple) directly with their fingers and bring it up to their mouth to consume it.

FIG. 21 shows a wristband 2103 that is worn around the person's wrist in a manner like a wrist-watch strap or a bracelet. Attached to wristband 2103 is a compound member that includes one or more sensors that collect information concerning food consumption and a data processing and transmission unit. In this example, this compound member includes: data processing and transmission unit 2104; motion sensor 2105; microphone and speaker unit 2106; and miniature video camera 2107. In an example, the person may wear one such device on each wrist.

In various examples, there may be one or more sensors in this compound member. In an example, these sensors can be selected from the group consisting of: accelerometer, inclinometer, other motion sensor, chewing sensor, swallow sensor, voice or other sound sensor, smell or olfactory sensor, blood pressure sensor, heart rate sensor, EEG sensor, ECG sensor, EMG sensor, electrical sensor, chemical sensor, gastric activity sensor, GPS sensor, camera or other image-creating sensor or device, optical sensor, piezoelectric sensor, respiration sensor, strain gauge, electrogoniometer, temperature sensor, and pressure sensor.

In various examples, a compound member such as the one shown in FIG. 21 can be worn directly on the person's body. Alternatively, it can be attached to the person's clothing. In various examples, this compound member can be worn on the person's wrist, neck, ear, head, arm, finger, mouth, or torso. In various examples, this compound member can be worn in a manner similar to a wrist watch, bracelet, necklace, pendant, button, belt, hearing aid, ear plug, headband, eyeglasses, bluetooth device, ear ring, or finger ring.

In an example, a compound member such as the one shown on wristband 2103 in FIG. 21 can be used to collect involuntary data concerning the person's food consumption, without requiring any voluntary actions by the person other than the actual actions of eating. In an example, a compound member such as this one can be used to collect voluntary data concerning the person's food consumption through voluntary actions by the person other than the actual actions of eating. In an example, the same compound member can be used to collect both involuntary data and voluntary data concerning the person's food consumption. In an example, collection of involuntary data vs. voluntary data concerning food consumption can be independent of each other. In an example, collection of involuntary and voluntary data can be causally linked. In an example, when involuntary data from a sensor indicates that the person is probably eating, then the device can prompt the person to provide voluntary data concerning what they are eating.

In an example, such a compound member can estimate the person's caloric intake based on both involuntary data and voluntary data concerning food consumption. In an example, a device can escalate data collection to a more-accurate, but also more-intrusive, level of involuntary data collection if the estimate of caloric intake from a less-intrusive level is not sufficiently accurate. In an example, the accuracy of estimates of caloric intake can be tested by comparing predicted weight gain or loss to actual weight gain or loss. In an example, if predicted and actual weight gain or loss do not meet the criteria for similarity and/or convergence, then the device can activate a level of automatic monitoring (and involuntary data collection) which is more-accurate, but also more-intrusive into the person's privacy and/or time.

In an example, this device gives the person an incentive to provide timely and accurate voluntary data concerning food consumption in order to avoid potentially more-intrusive sensor monitoring and involuntary data collection. Such a device and method can engage the person in their own energy balance and weight management to a greater degree than an entirely-involuntary device for automatic monitoring. Such a device and method can also ensure greater compliance and accuracy than an entirely-voluntary device for diet logging.

In the device embodiment that is shown in FIGS. 21 through 27, data processing and transmission unit 2104 analyzes data from one or more sensors. In this example, data processing and transmission unit 2104 receives data from motion sensor 2105, microphone and speaker unit 2106, and video camera 2107. This data processing and transmission unit is also able to communicate data to and from a remote computer.

In this example, motion sensor 2105 detects movement patterns of the person's hand that indicate that the person is probably eating. In an example, these movements may include reaching for food, grasping food (or a glass or utensil for transporting food), raising food up to the mouth, tilting the hand to move food into the mouth, pausing to chew or swallow food, and then lowering the hand. In an example, these movements may also include the back-and-forth hand movements that are involved when a person cuts food on a plate. In this example, a motion sensor is categorized as a relatively less-intrusive sensor, even though it operates continually to monitor possible eating events. In another example, a sound sensor may be used for this continuous, but less-intrusive, monitoring function. A sound sensor may continually monitor for eating events by monitoring for biting, chewing, and swallowing sounds.

In this example, microphone and speaker unit 2106 functions as a two-way voice-based user interface. In this example, microphone and speaker unit 2106 emits voice-based messages that are heard by the person wearing the device and this unit also receives voice-based messages from this person. In an example, data processing and transmission unit 2104 includes voice generation and voice recognition software. In an example, unit 2106 is used to prompt the person wearing the device to enter voluntary data concerning food consumption. In an example, unit 2106 is used to receive voluntary data (in voice form) concerning food consumption from this person. In other examples, this device may send messages to the person in voice form, but receive data from the person in another form such as through a keypad or touch screen. In other examples, this device can send messages to the person in non-voice form, such as a display screen, but receive messages from the person in voice form.

In the example of the device that is shown in FIGS. 21 through 27, miniature video camera 2107 takes pictures of the person's hand and fingers, and also the space surrounding the person's hand and fingers, in order to detect and identify food. In this example, video camera 2107 need not operate continuously. In this example, video camera 2107 only operates when voluntary data and less-intrusive involuntary data do not combine to create sufficiently-accurate estimates of caloric intake. In this example, the accuracy of caloric intake estimation is tested by comparing predicted weight gain or loss (based on the caloric intake estimate) vs. actual weight gain or loss.

In an example, video camera 2107 can be activated to take pictures when other components of the device indicate that the person is probably eating. In an example, the operation of video camera 2107 can be triggered when motion sensor 2105 indicates that the person is probably eating. In another example, the operation of video camera 2107 can be triggered when a sound sensor indicates that the person is probably eating. In an example, the operation of video camera 2107 can be triggered when voluntary data received from the person, such as through microphone and speaker unit 2106, indicates that the person is eating.

In an example, video camera 2107 can have a fixed focal direction and focal length. In an example, the focal direction of the video camera may always point toward the person's fingers and the space surrounding the person's fingers. In another example, the video camera can have a focal direction or focal length that is automatically adjusted while the camera is in operation. In an example, when it is in operation, the video camera can scan back and forth through the space near the person's hand and fingers to search for food. In an example, the video camera can use pattern recognition to track the relative location of the person's fingers. In an example, the camera can automatically adjust its focal direction and/or focal length to monitor and identify eating-related objects (such as a fork or glass) that come into contact with the person's fingers.

In an example, video camera 2107 can scan in a spiral, radial, or back-and-forth pattern in order to monitor activity near both the person's fingers and the person's mouth. This is more complex than just tracking the person's fingers. This requires that the device keep track of where the person's fingers and mouth are, in three-dimensional space, relative to the camera as the person moves their arm, hand, and head. In an example, face recognition software can help the device to track the person's mouth and gesture recognition software can help the device to track the person's fingers.

In the example shown in FIG. 21, there is only one miniature video camera in this device and it is located on the outer portion of the person's wrist where the main body of a wrist watch would generally be located. In another example, such a device may have one video camera located on the opposite side of the person's wrist. In other examples, there may be two or more video cameras mounted on different locations around the person's wrist. In an example with two or more video cameras, different cameras may track different objects. For example, one camera may track the person's fingers and the other camera may track the person's mouth. In various examples, different cameras may operate at different times and/or with different focal lengths.

FIGS. 21 through 27 show this device in sequential stages of operation as it progressively monitors the person's food consumption and estimates the person's caloric intake. FIG. 22 shows the device as it is tilted when the person the tilts their hand 2101 upwards to bring glass 2102 up to their mouth to drink. This tilting movement, especially when followed by a pause and then a reverse tilting movement, is detected and recognized by motion sensor 2105 as indicating a probable eating event.

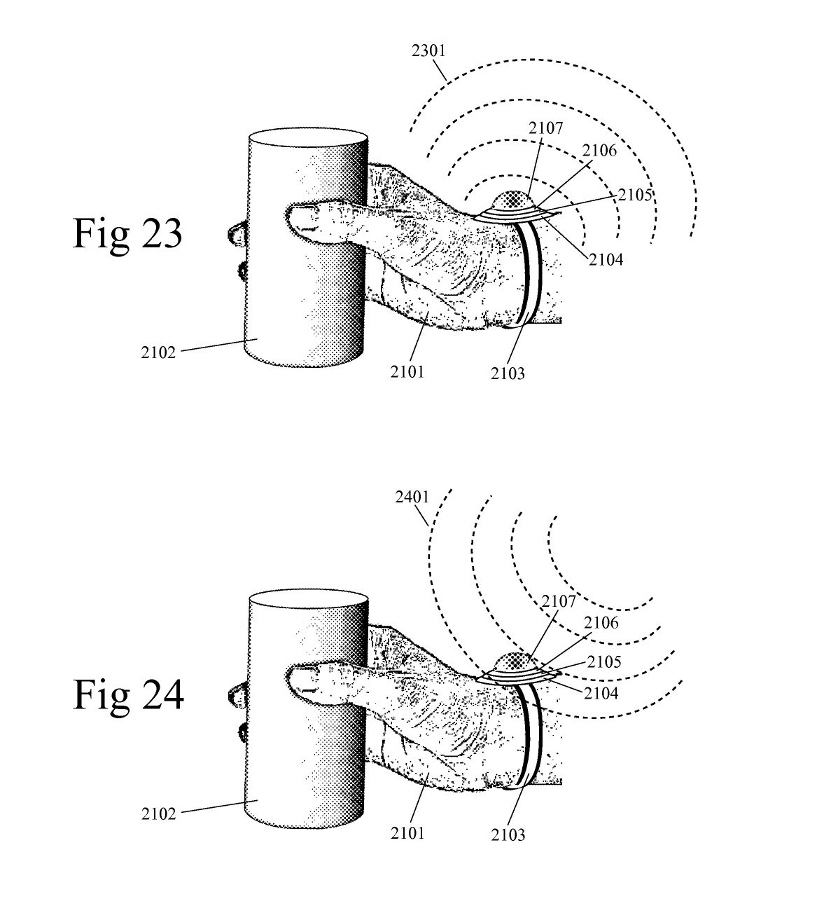

In FIG. 23, the motion sensor has detected this possible eating event (i.e. the glass being tilted up to the mouth and then back down) and this event has triggered a voice-based inquiry from the device to the person via microphone and speaker unit 2106. In an example, the device, upon detection of a probable eating event, can ask the person a question such as—“If you are eating something, please identify it.” The sound waves of this voice-based inquiry from the device are represented in FIG. 23 by concentric dotted lines 2301 expanding outward from the device. In this example, the device solicits voluntary data concerning food consumption from the person through a voice-based message. In other examples, a device may solicit voluntary data via other means such as a display screen, buzzing or ring tone, vibration, or text message.

In an example, solicitation or prompting of voluntary data collection concerning food consumption can occur in real time when the motion sensor first detects a possible eating event. In another example, solicitation of voluntary data may be delayed until after an eating event is finished. In another example, the device may keep a record of multiple eating events throughout the day and inquire about each during a cumulative data collection session at the end of the day. The latter is less intrusive with respect to eating events, but risks imprecision due to imperfect recall and “caloric amnesia.”

FIG. 24 shows the person responding to the voice-based prompt with voice-based data concerning what the person is eating. In an example, the person might respond to the device inquiry with the statement—“I am drinking a large glass of apple juice.” The person's voice-based response is received by microphone and speaker unit 2106. The sound waves of this voice-based response from the person are represented in FIG. 24 by concentric dotted lines 2401 expanding toward the device. In this example, the voice-based response that is received by microphone and speaker unit 2106 is analyzed and understood by data processing and transmission unit 2104. In another example, the voice-based response may be transmitted to, and analyzed by, a remote computer. In an example, voice recognition or speech recognition software can be used to analyze the voice-based response.

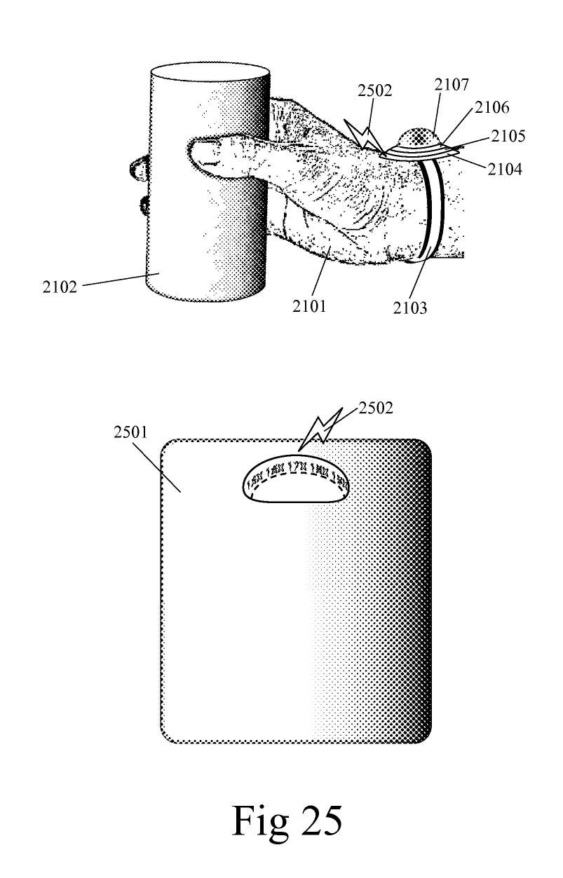

In the upper portion of FIG. 25, data processing and transmission unit 2104 has estimated the person's caloric intake. This estimate of caloric intake is based on involuntary data concerning food consumption collected by the motion sensor, voluntary data concerning food consumption received via the person's voice, or both involuntary data and voluntary data. In an example, an estimate of the person's caloric expenditure is subtracted from the estimate of the person's caloric intake in order to calculate the person's net energy balance and to predict the person's weight gain or loss. In an example, the estimate of caloric expenditure can come from a different device and be transmitted wirelessly to data processing and transmission unit 2104. In another example, the estimate of caloric expenditure can come from analysis of the person's activities as monitored by motion sensor 2105.

In an example, all of these data processing tasks can occur within the wearable device, such as within data processing and transmission unit 2104. In another example, some of these data processing tasks can occur within the wearable device and other tasks can occur in a remote computer. In an example, data can be transmitted back and forth from the wearable device to a remote computer via data processing and transmission unit 2104.

In an example, caloric intake may be estimated by combining involuntary data and voluntary data using weights from a multivariate linear estimation model; using a Bayesian statistical model; using linear or non-linear mathematical programming; or using other multivariate statistical methods. In an example, weights can be standardized based on empirical evidence from a large population. In an example, weights can be customized to a specific individual based on the individual's own eating habits, sensor output patterns, and diet logging behavior.

The bottom portion of picture in FIG. 25 shows scale 2501. The person's actual weight is measured when the person stands on scale 2501 and this weight value is then transmitted wirelessly to data processing and transmission unit 2104 of the wearable device. This wireless transmission is figuratively represented by lightning bolt symbol 2502. Actual weight gain or loss is determined by changes in weight measurements between different times. The predicted weight gain or loss (based on estimated caloric intake and caloric expenditure) for the person is compared to actual weight gain or loss for the person. If the predicted and actual weight gain or loss meet the criteria for similarity and/or convergence, then the device does not need to gather more information about food consumption.

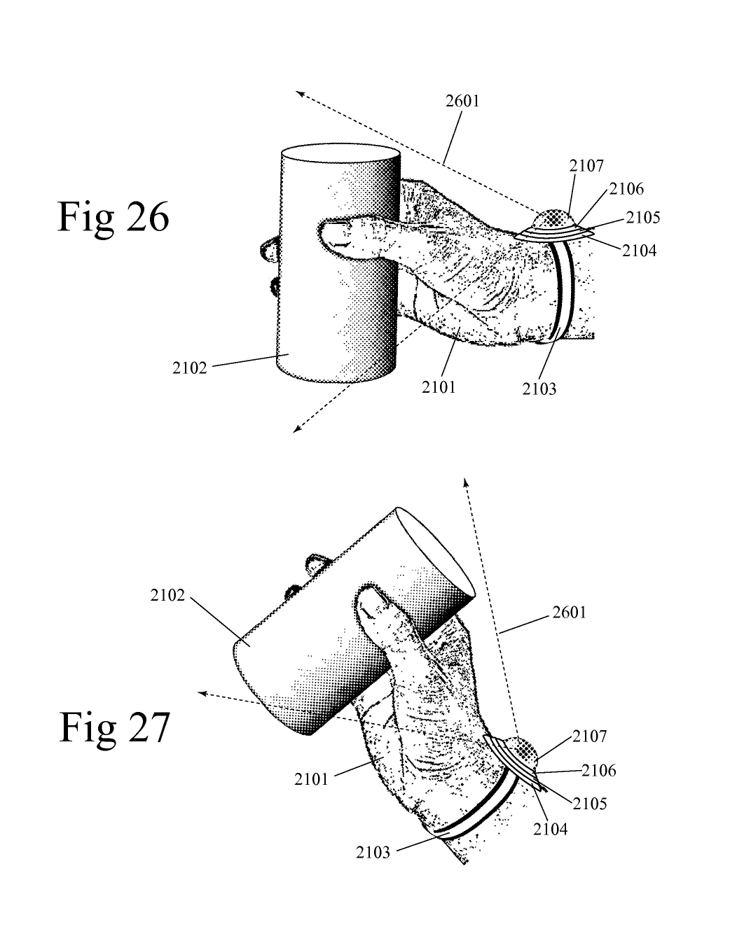

However, if the predicted and actual weight gain or loss do not meet the criteria for similarity and/or convergence, then the device escalates collection of involuntary data concerning food consumption to a more-accurate (but also more-intrusive) level, as shown in FIGS. 26 and 27. In FIGS. 26 and 27, miniature video camera 2107 is activated to take pictures to detect and identify food consumption. In an example, video camera 2107 is only activated when predicted and actual weight gain or loss fail to meet the criteria for similarity and/or convergence. In an example, the person can avoid being monitored by the video camera if the person provides accurate and timely voluntary data concerning food consumption in the voice-based exchange that is shown in FIGS. 23 and 24. This provides an incentive for the person to be actively and accurately engaged in monitoring their own caloric intake and managing their own energy balance.

FIGS. 26 and 27 show how miniature video camera 2107 can track a food-transporting member (such as glass 2102) as it is lifted upwards towards the person's mouth, paused during consumption of the food, and then lowered back down. Food is broadly defined herein to include beverages as well as solid and semi-solid food. In an example, the resulting images of food or food containers can be automatically analyzed to estimate the types and quantities of food consumed. In addition to the color, texture, and volume of food itself, features of food containers and packages may also be analyzed to identify food. For example, if the hand in FIGS. 26 and 27 were holding a beverage can instead of a glass, then the image analysis might recognize a logo on the can in order to identify the beverage.

If a person really wanted to “fool” this device, they could do so in the short run. For example, they could pour a less-healthy beverage into the empty can of a more-healthy beverage, before consuming the less-healthy beverage in view of the camera. The camera might be “fooled” by the logo on the can into thinking that the person drank the more-healthy beverage. However, over the long run, such deception would show up in discrepancies between predicted and actual weight gain or loss. These discrepancies could result in further escalation of involuntary data collection with diverse sensors with more-continuous operation. Overall, the device and method disclosed herein provides incentives for the person to be engaged in honest, accurate, and timely voluntary reporting of food consumed in order to avoid escalation of involuntary data collection.

In various examples, analysis and identification of food or food packaging can include one or more methods selected from the group consisting of: food recognition or identification; visual pattern recognition or identification; chemical recognition or identification; smell recognition or identification; word recognition or identification; logo recognition or identification; bar code recognition or identification; and 3D modeling. The results of this image data and analysis can then be used to improve the accuracy of caloric intake estimation.

We now digress to discuss in more depth the rationale for escalating involuntary data collection in response to inaccurate voluntary data. Such escalation can be viewed as intrusive, but it can also be viewed in the context of who initiates it and what purpose it serves. Few human beings are constant in their willpower and resolve. Most people have times of strength and moments of weakness. This includes moments of strength and weakness when it comes to achieving health goals such as losing weight. People have strong moments wherein their willpower and resolution to achieve a health goal (such as losing weight or quitting smoking) are high. People also have weak moments wherein their willpower and resolution to achieve this goal are low. How can a person extend their strength of resolve from a peak moment in order to shore up their low willpower at moments of weakness?

This device and method provide a way for the person to strengthen their willpower and resolve at low moments. In an example, a person can decide to start wearing this device at a time of relatively high willpower and resolution to lose weight. Once the person starts wearing the device, its interactive nature and incentives help to strengthen the person's willpower at their moments of weakness. If potentially-escalating monitoring in response to inaccurate voluntary reporting of food consumption is initiated by the person and helps them to reach an important health goal, then it can be a good thing in the long run. This device and method can help the person to shore up their willpower in moments of personal weakness by a decision that they make at a time of personal strength.

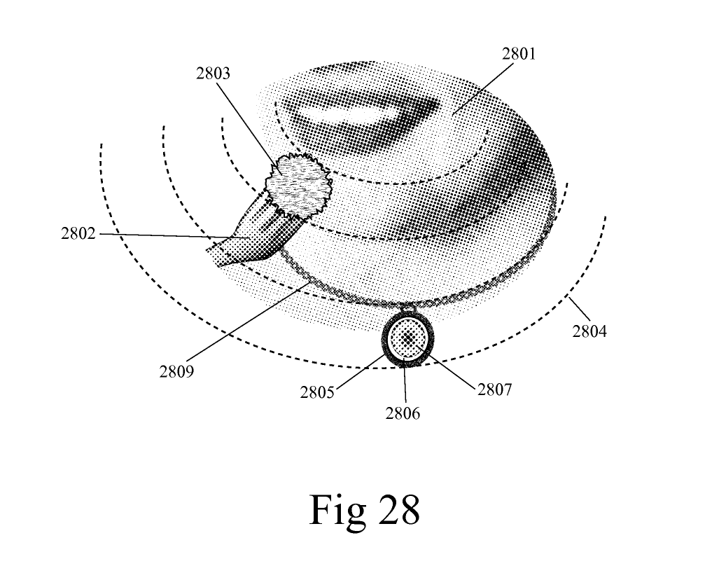

FIGS. 28 through 31 show another example of how this invention may be embodied in a wearable device that measures a person's caloric intake. FIGS. 28 through 31 show the structure and operation of this wearable device in a sequence of operations during food consumption.

FIG. 28 shows a person's mouth 2801, a food-transporting member 2802, and a piece of food 2803 being transported to the person's mouth 2801 via the food-transporting member 2802. In this example, food-transporting member 2802 is a fork. In other examples, food-transporting member can be a spoon or a beverage container. In another example, this device can also work if the person uses their fingers directly to bring food up to their mouth.

FIG. 28 also shows an ornamental chain 2809 that is worn around the person's neck like a necklace. FIG. 28 also shows an oval compound member that is worn on the necklace like a pendant. In this example, this oval compound member includes three parts: (a) a wireless data processing and transmission unit 2805 that communicates with a remote scale; (b) a microphone and speaker unit 2806 with voice recognition capability; and (c) a miniature video camera 2807 that automatically takes pictures of food as it is transported by the person's hand up to their mouth.

In another example, a compound member such as the one shown on a necklace in FIG. 28 can be worn on a person's clothing as a button or a brooch instead of being worn like a pendant on a necklace. In another example, such a compound member may be worn on a person's ear like an ear ring. In another example, such a compound member may be incorporated into a person's eyeglasses.

In this example, microphone and speaker unit 2806 continually monitors sounds for biting, chewing, or swallowing sounds that indicate that the person is probably eating something. As the person inserts food 2803 into their mouth and begins to bite, chew, and swallow, these sounds are detected by microphone and speaker unit 2806. The sound waves comprising with these biting, chewing, and swallowing sounds are represented by concentric dotted lines 2804. In another example, chewing, biting, and swallowing sounds may be conducted through the person's body to microphone and speaker unit 2806, instead of (or in addition to) being conducted through the air. These sounds can be analyzed directly in microphone and speaker unit 2806 or they can be transmitted for analysis in data processing and transmission unit 2805. In an example, analysis of these sounds can indicate probable eating.

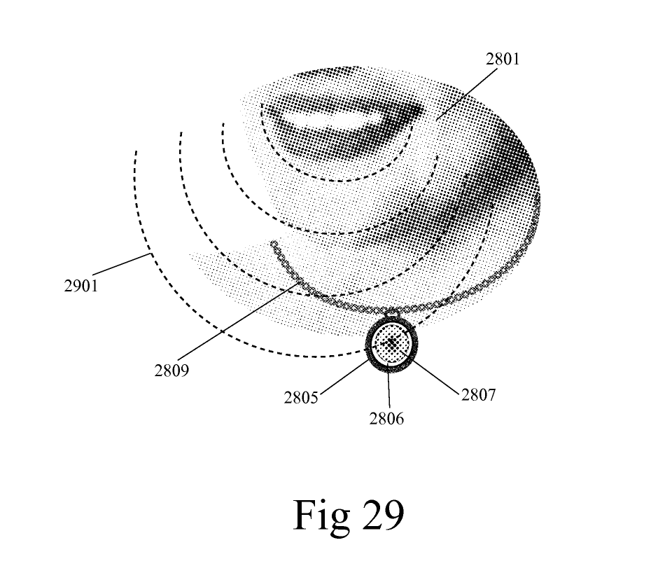

FIG. 29 shows another step in the operation of this device. In this step, the person provides voluntary data concerning what they will eat, are eating, or have eaten. In this example, this voluntary data is form of a voice message from the person and is received by microphone and speaker unit 2806. The sound waves of the person's voice are represented by concentric dotted lines 2901. In an example, the person's voice message can be analyzed using voice recognition software.

In an example, voluntary data provided by the person in this step can include information about the types and quantities of food consumed. In various examples, this data can be provided before, during, or after eating. In an example, voluntary data collection may be prompted or solicited in real time, when the microphone and speaker unit first detects probable eating. In another example, voluntary data collection may be prompted or solicited at the end of the day and may be associated with multiple eating events detected by the microphone and speaker throughout the day. In an example, voluntary data collection may be entirely independent; it may not be prompted or solicited at all.

In an example, data processing and transmission unit 2805 can estimate the person's caloric intake based on what the person says about what they are eating (voluntary data), based on biting, chewing, and swallowing sounds (involuntary data) or the combination of both of these data sources. In an example, data processing and transmission unit 2805 may transmit these data to a remote computer wherein the person's caloric intake is estimated.

In this example, an estimate of the person's caloric expenditure is subtracted from the above estimate of the person's caloric intake in order to calculate the person's net energy balance and to predict the person's weight gain or loss for a given period of time. There are many methods for measuring caloric expenditure in the prior art and the precise method is not central to this example, so it is not specified herein. In an example, these calculations and predictions can occur in data processing and transmission unit 2805. In another example, these calculations and predictions can occur in a remote computer that is in wireless communication with data processing and transmission unit 2805.

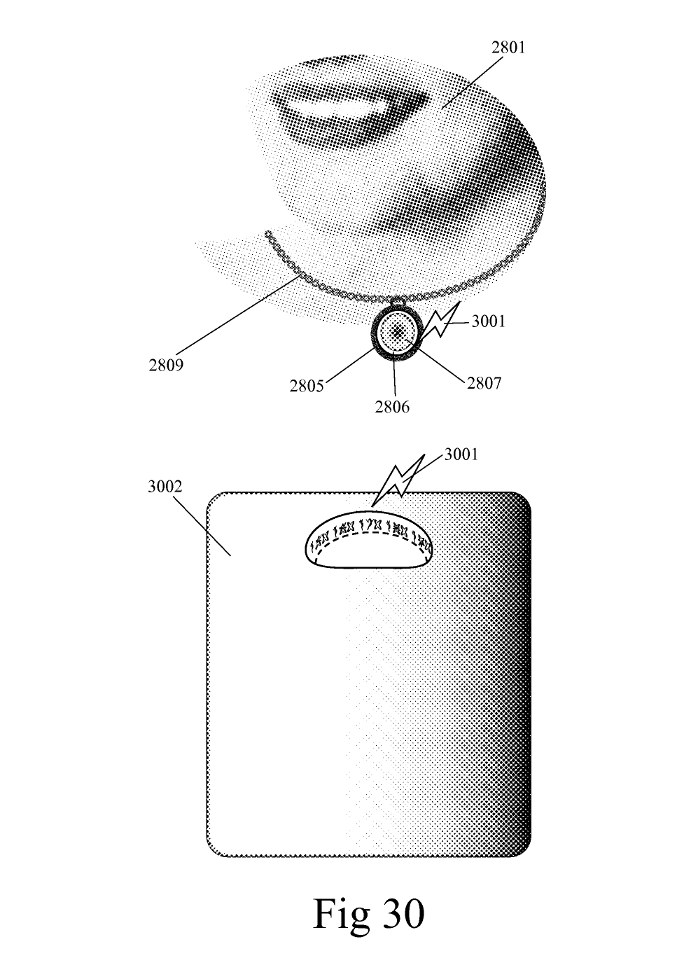

FIG. 30 shows the next step in the operation of this device. In an example, this next step may occur on a periodic basis, such as at the end of each day, each week, or each month. In this step, the person stands on scale 3002 and this scale wirelessly transmits the person's weight to data processing and transmission unit 2805. This wireless data transmission is represented by lightning bolt symbol 3001. The predicted weight gain or loss for the person is then compared to the actual weight gain or loss for the person for a period of time.

In this example, if the predicted weight gain or loss and the actual weight gain or loss for the person meet the criteria for similarity and/or convergence, then miniature video camera 2807 is never activated. In this example, video camera 2807 only operates when predicted and actual weight gain or loss do not meet the criteria for similarity and/or convergence. In this manner, this device provides the person with an incentive to provide timely and accurate voluntary data concerning food consumption in order to avoid more-intrusive (image-based) monitoring. This device thus engages the person in their own energy balance and weight management more so than an entirely-involuntary data collection device. It also provides greater compliance and accuracy than an entirely-voluntary data collection device.

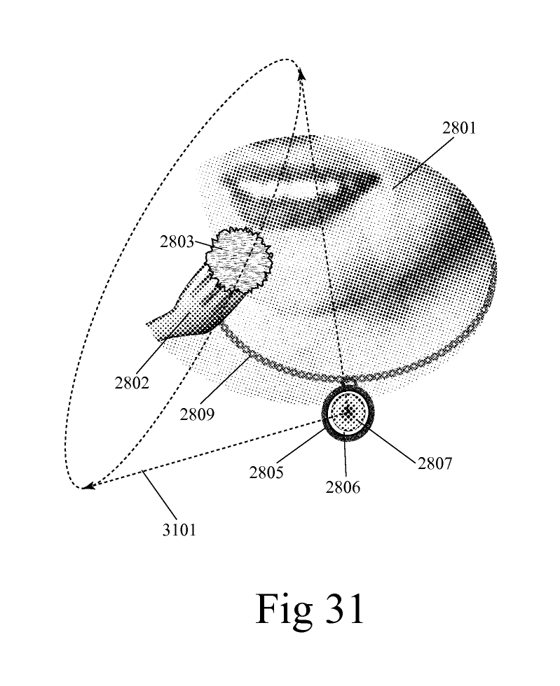

Finally, FIG. 31 shows how miniature video camera 2807 operates if the predicted weight gain or loss (based on the prior steps of voluntary and involuntary data collection) does not meet the criteria for similarity and/or convergence with actual weight gain or loss. In the absence of such similarity and/or convergence, the device activates video camera 2807 to monitor for food consumption. The results of this video monitoring are then used to improve the measurement of caloric intake. In an example, the person could have avoided monitoring by the video camera if the person had provided accurate and timely voluntary data concerning food consumption in the voice-based information shown in FIG. 29.

FIG. 31 shows how a miniature video camera 2807 that attached like a pendant to a necklace can track a food-transporting member 2802 (such as a fork) as it transports food 2803 towards the person's mouth 2801. In FIG. 31, the field of vision that is seen by miniature video camera 2807 is represented by dotted lines 3101. These dotted lines comprise a radially-extending circle that encompasses the space surrounding the person's fingers, including food 2803.

In an example, the resulting images of food 2803 can be automatically analyzed to estimate the types and quantities of food consumed. In various examples, analysis and identification of food and/or food packaging can include one or more methods selected from the group consisting of: food recognition or identification; visual pattern recognition or identification; chemical recognition or identification; smell recognition or identification; word recognition or identification; logo recognition or identification; bar code recognition or identification; and 3D modeling. The results of this new video data and analysis are then used to improve the accuracy of caloric intake estimation.

As shown in FIGS. 21 through 31, this invention can be embodied in a device for measuring a person's food consumption and/or caloric intake comprising: (a) a first sensor and/or user interface that collects a first set of data concerning what the person eats; (b) a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and (c) a second sensor and/or user interface that collects a second set of data concerning what the person eats if the criteria for similarity and/or convergence of predicted and actual weight change are not met. In an example, at least one of the sensors and/or user interfaces are worn by the person.

In an example, collecting the first set of data does not require voluntary actions by the person associated with particular eating events other than the actions of eating, but collecting the second set of data does require voluntary actions by the person associated with particular eating events other than the actions of eating. In an example, collecting the second set of data does not require voluntary actions by the person associated with particular eating events other than the actions of eating, but collecting the first set of data does require voluntary actions by the person associated with particular eating events other than the actions of eating.

In an example, the first set of data comprises image data whose collection requires voluntary actions by the person associated with particular eating events other than the actions of eating and the second set of data comprises image data whose collection is more continuous than that of the first set of data. In an example, the first set of data comprises image data whose collection is intermittent, periodic, or random, not requiring voluntary actions by the person associated with particular eating events other than the actions of eating, and the second set of data comprises image data whose collection is more continuous than that of the first set of data. In an example, the first set of data comprises image data whose collection is triggered by sounds, motions, or sounds and motions indicating an eating event, not requiring voluntary actions by the person associated with particular eating events other than the actions of eating, and the second set of data comprises image data whose collection is more continuous than that of the first set of data. In an example, the first set of data comprises sound data, motion data, or both sound and motion data and the second set of data comprises image data.

In an example, the first set of data can be received concerning what the person eats, wherein this first set includes involuntary data that is collected in a manner that does not require voluntary actions by the person associated with particular eating events other than the actions of eating, and wherein this first set also includes voluntary data that is collected in a manner that requires voluntary actions by the person associated with particular eating events other than the actions of eating.

As shown in FIGS. 21 through 31, this invention can be embodied in a device for measuring a person's food consumption and/or caloric intake comprising: (a) a first set of sensors and/or user interfaces that collect a first set of data concerning what the person eats, wherein this first set includes involuntary data that is collected in a manner that does not require voluntary actions by the person associated with particular eating events other than the actions of eating, and wherein this first set also includes voluntary data that is collected in a manner that requires voluntary actions by the person associated with particular eating events other than the actions of eating; (b) a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and (c) a second set of sensors and/or user interfaces that collect a second set of data concerning what the person eats if the criteria for similarity and/or convergence of predicted and actual weight change are not met.

As shown in FIGS. 21 through 31, this invention can be embodied in a device for measuring a person's food consumption and/or caloric intake comprising: (a) a first set of sensors and/or user interfaces that receive a first set of data concerning what the person eats, wherein this first set includes involuntary data that is received in a manner that does not require voluntary actions by the person associated with particular eating events other than the actions of eating, and wherein this first set also includes voluntary data that is received in a manner that requires voluntary actions by the person associated with particular eating events other than the actions of eating; (b) a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and (c) a second set of sensors and/or user interfaces that receive a second set of data concerning what the person eats if the criteria for similarity and/or convergence of predicted and actual weight change are not met.

I claim:

1. A method for measuring a person's caloric intake comprising:
receiving a first set of data concerning what the person eats from a first source and receiving a second set of data concerning what the person eats from a second source;
calculating a first estimate of the person's caloric intake based on the first set of data, calculating a second estimate of the person's caloric intake based on the second set of data, and comparing these first and second estimates of caloric intake to determine whether these estimates meet criteria for similarity and/or convergence; and
if the first and second estimates of caloric intake do not meet the criteria for similarity and/or convergence, then receiving a third set of data concerning what the person eats and calculating one or more new estimates of caloric intake using this third set of data.

2. The method in claim 1 wherein collection of the first set of data does not require voluntary actions by the person associated with particular eating events other than the actions of eating, but collection of the second set of data does require voluntary actions by the person associated with particular eating events other than the actions of eating, or vice versa.

3. The method in claim 1 wherein data sets are selected from the group consisting of: (a) at least one of the first set of data and the second set of data comprises image data whose collection requires voluntary actions by the person associated with particular eating events other than the actions of eating and the third set of data comprises image data whose collection is more continuous than the collection of at least one of the first and second sets of data; (b) at least one of the first set of data and the second set of data comprises image data whose collection is intermittent, periodic, or random, not requiring voluntary actions by the person associated with particular eating events other than the actions of eating, and the third set of data comprises image data whose collection is more continuous than the collection of at least one of the first and second sets of data; and (c) at least one of the first set of data and the second set of data comprises image data whose collection is triggered by sounds, motions, or sounds and motions indicating an eating event, this collection does not require voluntary actions by the person associated with particular eating events other than the actions of eating, and the third set of data comprises image data whose collection is more continuous than the collection of at least one of the first and second sets of data.

4. The method in claim 1 wherein at least one of the first set of data and the second set of data comprises sound data, motion data, or both sound and motion data and the third set of data comprises image data.

5. The method in claim 1 wherein the criteria for similarity and/or convergence are selected from the group consisting of: raw difference between two values is less than a target value; percentage difference between two values is less than a target value;
mathematical analysis of paired variables predicts convergence between them; and
statistical analysis of two variables does not show a statistically-significant difference between them.

6. A method for measuring a person's caloric intake comprising:
receiving a first set of data concerning what the person eats;
calculating a first estimate of the person's caloric intake based on the first set of data, using this first estimate of the person's caloric intake to estimate predicted weight change for the person during a period of time, and comparing predicted weight change to actual weight change to determine whether predicted weight change and actual weight change meet criteria for similarity and/or convergence; and
if predicted weight change and actual weight change do not meet the criteria for similarity and/or convergence, then receiving a second set of data concerning what the person eats and calculating a second estimate of caloric intake using this second set of data.

7. The method in claim 6 wherein collecting the first set of data does not require voluntary actions by the person associated with particular eating events other than the actions of eating, but collecting the second set of data does require voluntary actions by the person associated with particular eating events other than the actions of eating.

8. The method in claim 6 wherein collecting the second set of data does not require voluntary actions by the person associated with particular eating events other than the actions of eating, but collecting the first set of data does require voluntary actions by the person associated with particular eating events other than the actions of eating.

9. The method in claim 6 wherein the first set of data comprises image data whose collection requires voluntary actions by the person associated with particular eating events other than the actions of eating and wherein the second set of data comprises image data whose collection is more continuous than that of the first set of data.

10. The method in claim 6 wherein the first set of data comprises image data whose collection is intermittent, periodic, or random, not requiring voluntary actions by the person associated with particular eating events other than the actions of eating, and wherein the second set of data comprises image data whose collection is more continuous than that of the first set of data.

11. The method in claim 6 wherein the first set of data comprises image data whose collection is triggered by sounds, motions, or sounds and motions indicating an eating event, not requiring voluntary actions by the person associated with particular eating events other than the actions of eating, and wherein the second set of data comprises image data whose collection is more continuous than that of the first set of data.

12. The method in claim 6 wherein the first set of data comprises sound data, motion data, or both sound and motion data, and wherein the second set of data comprises image data.

13. A device for measuring a person's caloric intake comprising:
a first sensor and/or user interface that collects a first set of data concerning what the person eats;
a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and
a second sensor and/or user interface that collects a second set of data concerning what the person eats if the criteria for similarity and/or convergence of predicted and actual weight change are not met.

14. The device in claim 13 wherein at least one of the sensors and/or user interfaces are worn by the person.

15. The device in claim 13 wherein collecting the first set of data does not require voluntary actions by the person associated with particular eating events other than the actions of eating, but collecting the second set of data does require voluntary actions by the person associated with particular eating events other than the actions of eating.

16. The device in claim 13 wherein collecting the second set of data does not require voluntary actions by the person associated with particular eating events other than the actions of eating, but collecting the first set of data does require voluntary actions by the person associated with particular eating events other than the actions of eating.

17. The device in claim 13 wherein the first set of data comprises image data whose collection requires voluntary actions by the person associated with particular eating events other than the actions of eating and wherein the second set of data comprises image data whose collection is more continuous than that of the first set of data.

18. The device in claim 13 wherein the first set of data comprises image data whose collection is intermittent, periodic, or random, not requiring voluntary actions by the person associated with particular eating events other than the actions of eating, and wherein the second set of data comprises image data whose collection is more continuous than that of the first set of data.

19. The device in claim 13 wherein the first set of data comprises image data whose collection is triggered by sounds, motions, or sounds and motions indicating an eating event, not requiring voluntary actions by the person associated with particular eating events other than the actions of eating, and wherein the second set of data comprises image data whose collection is more continuous than that of the first set of data.

20. The device in claim 13 wherein the first set of data comprises sound data, motion data, or both sound and motion data and wherein the second set of data comprises image data.
